(19) United States
(12) Patent Application Publication
(10) Pub. No.: US 2014/0012469 A1
(43) Pub. Date: Jan. 9, 2014

(54) VEHICLE INFORMATION PROCESSING DEVICE

(71) Applicants: Yoji Kunihiro, Susono-shi (JP); Takeshi Goto, Toyota-shi (JP); Masaki Fujimoto, Susono-shi (JP); Keitaro Niki, Susono-shi (JP); Ryo Irie, Toyota-shi (JP)

(72) Inventors: Yoji Kunihiro, Susono-shi (JP); Takeshi Goto, Toyota-shi (JP); Masaki Fujimoto, Susono-shi (JP); Keitaro Niki, Susono-shi (JP); Ryo Irie, Toyota-shi (JP)

(73) Assignee: TOYOTA JIDOSHA KABUSHIKI KAISHA, Toyota-shi (JP)

(21) Appl. No.: 14/006,240

(22) PCT Filed: Mar. 16, 2012
(86) PCT No.: PCT/JP12/56943

§ 371 Date: Sep. 19, 2013

(30) Foreign Application Priority Data
Mar. 23, 2011 (JP) 2011-064680
Jul. 5, 2011 (JP) 2011-149570

(51) Int. Cl. B62D 6/00

(52) U.S. Cl. CPC B62D 6/001
USPC 701/41

(57) ABSTRACT

A vehicle information processing device mounted on a vehicle includes a future position calculating unit configured to calculate a future position of the vehicle based on steering input information corresponding to a steering input, a vehicle state amount that prescribes a turning state, and a vehicle speed, and an estimating unit configured to estimate a turning curvature of the vehicle at a provisional travel position ahead of a present position based on at least three vehicle positions according to the vehicle including at least the one calculated future position as well as including a vehicle position corresponding to the present position of the vehicle. As a result, a turning curvature of the vehicle at a vehicle position ahead of a present position can be estimated by a simple configuration and further the estimated turning curvature can be preferably used to stabilize vehicle behavior.

### FIELD

The present invention relates to a technical field of a vehicle information processing device that is preferably mounted on a vehicle including various steering mechanisms, for example, an EPS (Electronic Controlled Power Steering Device), a VGRS (Variable Gear Ratio Steering Device), and the like and can be used to realize a desired travel locus.

### BACKGROUND

In this kind of the technical field, Patent Literature 1 discloses a device that calculates a road shape by adding position information of a GPS (Global Positioning System) and the like.

Further, Patent Literature 2 discloses a navigation device that estimates a shape of a curve based on road law information which causes road network data, road construction time, and a curvature law table to correspond to each other.

Further, Patent Literature 3 discloses a vehicle control device that calculates a road curvature based on road shape information and interrupts a lane travel support in response to the road curvature.

### CITATION LIST

### Patent Literatures

Patent Literature 1: Japanese Patent Application Laid-open No. 2004-272426
Patent Literature 2: Japanese Patent Application Laid-open No. 2010-151691
Patent Literature 3: Japanese Patent Application Laid-open No. 2006-031553

### SUMMARY

### Technical Problem

Although a GPS can generally provide highly accurate absolute position information, the absolute position information may include a large error occasionally, and, in the case, there is a possibility that a calculated road shape is greatly different from an actual road shape. Further, although it is possible to pickup a vehicle peripheral portion by an image pickup means such as a vehicle-mounted camera and the like and to estimate a curvature of a travel road of a vehicle, since the system is ordinarily expensive and further processing is complex, cost is increased.

Further, as a more serious problem, a curvature of a road (which means a road shape in short) does not necessarily coincide with a turning curvature of a vehicle intended by a driver. Accordingly, even if a curvature of a road at a position ahead of a present position is estimated with sufficient accuracy in practical use, it is difficult to realize behavior control of a vehicle in conformity with an intention and a feeling of a driver. In particular, in a medium and high vehicle speed range, a driver executes steering operation putting his or her eyes on a travel road ahead of a present position of a vehicle and unconsciously assuming a travel road to which the driver will reach thereafter in many cases. Accordingly, in steering control according to a curvature of a travel road and a turning curvature of the vehicle at a present position, a steering feeling provided to the driver does not necessarily coincide with a feeling of the vehicle. That is, there is a technical problem in that it is almost practically impossible for the conventional technical ideas including those described above to provide a preferable steering feeling without increasing cost.

A subject of the present invention, which was made in view of the technical problems described above is to provide a vehicle information processing device capable of estimating a turning curvature of a vehicle at a vehicle position ahead of a present position by a simple configuration. Furthermore, preferably, a subject of the present invention is to provide a vehicle information processing device capable using the estimated turning curvature to stabilize vehicle behavior.

### Solution to Problem

In order to solve the above mentioned problems, a vehicle information processing device according to the present invention mounted on a vehicle, includes a future position calculating means configured to calculate a future position of the vehicle based on steering input information corresponding to a steering input, a vehicle state amount that prescribes a turning state, and a vehicle speed; and an estimating means configured to estimate a turning curvature of the vehicle at a provisional travel position ahead of a present position based on at least three vehicle positions according to the vehicle including at least the one calculated future position as well as including a vehicle position corresponding to the present position of the vehicle (claim 1).

As a preferable mode, the vehicle information processing device according to the present invention is configured including a computer device, a processor, and the like and appropriately including a memory, a sensor, and the like when necessary.

The future position calculating means calculates a future position which means a vehicle position at a future point of time ahead of a present time based on, for example, steering input information as to a steering input such as a steering angle and the like and based on, for example, a vehicle state amount and a vehicle speed including, for example, a yaw rate, lateral acceleration and a vehicle body slip angle, and the like (hereinafter, wording “reference element group” is appropriately used as wording that integrates the matters described above). Note that although the vehicle position can include, as a concept, an absolute position prescribed by latitude and longitude and a relative position with respect to a reference position that can be optionally set, it is sufficient to acquire at least the latter position from a viewpoint of developing it to vehicle motion control, and the vehicle position preferably means the latter position.

It is considered that a driver applies a steering input via a steering input means (for example, steering wheel) based on other reference element (vehicle speed and vehicle state amount) other than steering input information and on a shape of a road (curvature of the road) which is visually recognized by the driver and is located at a vehicle position ahead of a present position. That is, it can be considered that the steering input applied from the driver includes information as to a travel position to which a vehicle reaches in a near future. In view of the above point, it is possible to construct a kind of a calculation model, a calculation rule, and the like for predicting the future position as a position displacement amount from a reference position (for example, the present position corresponding to a present time and a past position corresponding to a certain past point of time (past time)) based on, for example, the reference element group and to estimate the future position of a vehicle which changes momentarily by repeating calculation or operation according to the calculation model or the calculation rule. Note that the future position is not necessarily limited to one position because the future position is a predictive vehicle position in a near future to which the vehicle does not yet reach.

For example, the future position calculating means may determine, as a first process, the present position and the past position of a vehicle and may determine, as a second process, the future position by a mathematical and geometrical analyzing method based on the present position and the past position and the reference element group. The past position and the present position of the vehicle can be determined from a history of the reference element group during, for example, a definite or indefinite period from past to present. A vehicle position at a desired time (in the case, a cumulated value of a position change amount (coordinate change amount) to a reference position (reference coordinate) prescribed by a secondary coordinate system) may be determined by determining a locus of a vehicle (for example, a locus of a center of gravity) as a time function from a value of the reference element group for a past predetermined period as well as substituting a desired time value for the time function. Otherwise, a history of the present position that is continuously determined from past to present may be used as the past position. Further, the past position and the present position may be appropriately acquireed via a car navigation device and various communication systems between a road and a vehicle, and the like.

According to the vehicle information processing device according to the present invention, in a process in which the future position is calculated by the future position calculating means at a definite or indefinite time cycle momentarily, a turning curvature of a vehicle at a provisional travel position ahead of the present position (which may be one of calculated future positions) is estimated by the estimating means.

The turning curvature of the vehicle that does not necessarily coincide with the road curvature can be considered as an inverse number of a radius of an imaginary circle drawn by the vehicle as, for example, a locus of a position of its center of gravity. Since the imaginary circle can be prescribed by a center position (center coordinate) in a secondary coordinate system and three elements of a radius, when at least three points of a center of gravity that prescribes a locus of the center of gravity can be acquired, the imaginary circle can be determined based on an equation for calculating a locus of a circle. The estimating means according to the present invention can estimate a turning curvature of a vehicle at a provisional travel position based on at least three vehicle positions including at least one future position calculated by the future position calculating means as well as including a vehicle position correspond to the present position of the vehicle making use of what is described above.

Note that the wording “the vehicle position corresponding to the present position” means a vehicle position directly related to the present position and means, for example, the present position itself determined in the first process described above or the future position calculated based on the present position. When the vehicle position corresponding to the present position as described above is included as a reference value according to an estimation of a turning curvature, the imaginary circle as a locus of the vehicle position can be definitely determined with high accuracy. Note that when “the future position calculated based on the present position” is included in the at least three vehicle positions referred to by the estimating means, “the calculated future position” may mutually coincide with “the vehicle position corresponding to the present position of the vehicle”.

When the estimating means estimates the turning curvature at the provisional travel position, at least conceptually, a relatively high degree of freedom is given as to what vehicle position is to be referred to as at least one remaining vehicle position. However, as to the past position of the vehicle, as a deviation on a time axis between a past point of time according to the past position to be referred to and a present point of time (present time) increases, since an influence, which is applied to the turning curvature at the provisional travel position that is reached by the past position to be referred to at a future point of time ahead of a present point of time, becomes smaller, the past position that can be practically used to estimate the turning curvature naturally restricted. When, for example, a process in which a vehicle center of gravity is calculated momentarily at a certain cycle is considered, since the past position that can be used to estimate a turning curvature at a provisional travel position is only one or two samples in the past, the past position may not be ideally referred to.

Likewise, as to the future position of the vehicle, as a deviation on a time axis between a future point of time according to the future position to be referred to and a present point of time (present time) increased, since estimation accuracy of the future position is lowered (the future position which influences a steering input of a driver is a vehicle position in a near future region ahead of, for example, several to several tens of seconds, it is almost meaningless practically to estimate the vehicle position at a point of time ahead of the vehicle position in the near future region), the future position that can be practically used to estimate the turning curvature is naturally restricted.

When these points are taken into consideration, the estimating means may estimate, as a preferable mode, the turning curvature based on three vehicle positions, i.e., the future position corresponding to the present position, the future position corresponding to the past position ahead of one sampling time (that is, the future position calculated at a certain past point of time), and the future position corresponding to the past position ahead of two sampling times (that is, in the case, at least three future positions are calculated ahead of the present position). Otherwise, the estimating means may estimate, as a preferable mode, the turning curvature based on three vehicle positions, i.e., the future position corresponding to the present position, the future position corresponding to the past position ahead of one to several sampling times, and the present position (that is, in the case, plural future positions are calculated ahead of the present position).

As described above, according to the vehicle information processing device according to the present invention, the turning curvature of the vehicle itself in conformity with an intention and a feeling of a driver at the provisional travel position ahead of the present position can be estimated without making use of a system, for example, a vehicle-mounted camera and the like that increases cost. Accordingly, when various kinds of a steering mechanism that can be mounted on a vehicle is controlled, it is possible to provide a steering feeling which is in conformity with an intention and a feeling of a driver without an uncomfortable feeling can be provided to the driver.

In one aspect of the vehicle information processing device according to the present invention, the future position calculating means obtains a present position and a past position of the vehicle as well as calculates the future position based on the acquired present position and past position, steering input information corresponding to the steering input, a vehicle state amount that prescribes a turning state, and a vehicle speed (claim 2).

According to the aspect, the future position calculating means first acquires the present position and the past position and calculates the future position based on the acquired present position and past position and a reference element group. Since the future position is influenced by a locus of a vehicle that continues from the past position to the present position and the reference element group at the present position, a calculating process of the future position that has passed through plural stages and reflects the locus of the vehicle from past to present is rational as well as meaningful practically in the point that the future position can be estimated with high accuracy.

Note that when the present position and the past position are acquired, a numerical value calculation (for example, a calculation for determining a locus of a center of gravity, a calculation for calculating a position from the determined locus, and the like) may be executed based on the reference element group as described above and information may be acquired via a navigation device and a communication system between a road and a vehicle, and the like. Further, as to the past position, when the present position continuously acquired on a time axis is stored by being caused to correspond to an elapsed time, the past position may be acquired by reading out the stored value.

In another aspect of the vehicle information processing device according to the present invention, the future position is a relative position prescribed by a relative position change amount with respect to a reference position (claim 3).

According to the aspect, since the future position is prescribed as a relative position change amount with respect to an optionally set reference position, a load necessary to a calculation or a storage is relatively small. Further, a development to the vehicle motion control is taken into consideration, practically, it is more preferable to prescribe the vehicle position as the relative position.

In still another aspect of the vehicle information processing device according to the present invention, further including a detecting means configured to detect the vehicle state amount, wherein the future position calculating means makes use of the detected vehicle state amount to calculate the future position (claim 4).

According to the aspect, since the future position is calculated based on the highly accurate vehicle state amount detected by the detecting means such as various sensors, reliability of a calculated future position can be improved. Note that the future position calculating means according to the present invention can also estimate the vehicle state amount based on the vehicle speed and the steering input information at the point of time regardless whether or not this kind of the detecting means is provided.

In still another aspect of the vehicle information processing device according to the present invention, the steering input information is a steering angle, and the vehicle state amount is a yaw rate, lateral acceleration, and a vehicle body slip angle (claim 5).

According to the aspect, the steering angle is employed as the steering input information and further the yaw rate as the vehicle state amount, the lateral acceleration, and the vehicle body slip angle (a lateral slip angle between a travel direction of a vehicle body and a center line of a steering wheel), respectively. Since the steering angle is a rotation angle of various kinds of a steering input means such as the steering wheel and the like that is operated by the driver to apply a steering input, the steeling angle is optimum as steering input information reflecting the intention of the driver. Further, the yaw rate, the lateral acceleration, and the vehicle body slip angle are preferable as the vehicle state amount for prescribing turning behavior of the vehicle. Thus, according to the aspect, the future position can be calculated with relatively high accuracy.

In still another aspect of the vehicle information processing device according to the present invention, the at least three vehicle positions include three vehicle positions whose calculated times are adjacent to each other on a time series (claim 6).

When three vehicle positions in which the calculated times continue to each other on a time series are included as the vehicle positions that are referred to when the turning curvature of the vehicle at the provisional travel position is estimated, an imaginary circle can be definitely determined with high accuracy as a locus of a future vehicle position, which is practically useful.

In still another aspect of the vehicle information processing device according to the present invention, the vehicle includes at least one of a steering angle variable means capable of changing a relation between the steering input and a steering angle of a steering wheel and an assist torque supplying means capable of supplying assist torque for assisting steering torque of a driver; and the vehicle information processing device further includes a control means configured to control at least one of the steering angle variable means and the assist torque supplying means based on the estimated turning curvature (claim 7).

According to the aspect, the vehicle is configured including at least one of the steering angle variable means and the assist torque supplying means.

The steering angle variable means is a means capable of ambiguously changing a relation between the steering input and the steering angle of the steering wheel and preferably means a front wheel steering angle variable device such as a VGRS and the like, a rear wheel steering angle variable device such as an ARS (Active Rear Steering device) or a by-wire device such as an SBW (Steer By Wire: Electronic Controlled Steering Angle Variable Device).

The assist torque supplying means is a means capable of supplying assist torque for assisting steering torque applied by the driver via the steering input means such as the steering wheel and preferably means an EPS (Electric Power Steering: Electric Power Steering Device) and the like.

Note that the assist torque is torque capable of being acted in the same direction as or in a direction opposite to the steering torque of the driver (appropriately refer as “the driver steering torque”). When the assist torque is acted in the same direction as the driver steering torque, the assist torque can reduce a steering load of the driver (assist in a narrow sense), whereas when the assist torque is acted in the direction opposite to the driver steering torque, the assist torque can increase the steering load of the driver or can operate the steering wheel in a direction opposite to the steering direction of the driver (this is also within the category of assist in a wide sense). Further, a control target of the assist torque may be set as a cumulated value of plural control terms such as an inertia control term corresponding to inertia characteristics of the steering mechanism, a dumping control term corresponding to viscosity characteristics of the steering mechanism, and the like, and, in the case, various steering feelings can be realized according to control modes of the respective control terms, for example, a mode set to various gains, and the like. Further, when the assist torque is acted in a direction where a steering reaction force (in short, a reaction force caused by self-aligning torque acting around a king pin shaft of the steering wheel) transmitted from the steering wheel to the steering input means (in short, steering wheel) is cancelled, the steering reaction force can be reduced or cancelled.

According to the aspect, the control means is provided as a means capable of controlling the steering angle variable means or the assist torque supplying means or both of them, so that at least one of the steering angle variable means and the assist torque supplying means is controlled based on the turning curvature of the vehicle at the provisional travel position estimated by the estimating means. Accordingly, road information at the provisional travel position ahead of the present position which is latently reflected to the steering input at the present point of time by the driver via eyesight can be reflected to the steering control of the vehicle at the present point of time, so that the steering feeling with less uncomfortable feeling can be realized in conformity with the feeling of the driver.

In still another aspect of the vehicle information processing device according to the present invention including a control means, further including an acquiring means configured to acquire a present position and a plurality of past positions of the vehicle, wherein the estimating means estimates the turning curvature of the vehicle at the present position based on the acquired present position and the plurality of past positions, and the control means controls the assist torque based on the estimated turning curvature of the provisional travel position and a turning curvature of the estimated present position at the time of cut back of the steering input means executed by the driver (claim 8).

According to the aspect, the turning curvature of the vehicle at the present position is estimated based on the present position and the plural past positions (that is, the at least three vehicle positions) acquired by the acquiring means likewise the turning curvature at the provisional travel position. Further, the control means controls the assist torque when the driver executes cutting-back operation of the steering input means (for example, the steering wheel) based on the turning curvature at the present position and the turning curvature at the provisional travel position which have been estimated.

Thus, according to the aspect, at the time of cut back operation executed by the driver, a natural steering feeling with less uncomfortable feeling is realized. Note that the assist torque control may be executed by adding a correction based on the turning curvatures to, for example, an ordinary value of the assist torque at the time of cutting-back. Further, the control means may execute the control, as a preferable mode, in a medium and high speed range (a reference can be appropriately determined) in which it is likely that the steering feeling is deviated from the feeling of the driver.

Note that, as described above, when the future position calculating means employs such a configuration that it appropriately acquires the present position and the past position in a process for calculating the future position, “the acquiring means” in the aspect is a concept capable of being replaced with the future position calculating means. Further, even if the acquiring means is configured as a means different from the future position calculating means, a practical aspect when the acquiring means acquires the present position and the past position may be the same as the various aspects described above.

In addition, in the aspect, when a difference between a last time value of the estimated turning curvature of the provisional travel position and a present value of a turning curvature of the estimated present position is larger, the control means may more increase the assist torque (claim 9).

A last time value of the estimated turning curvature is substantially a turning curvature at the present point of time which is previously expected by the driver via eyesight, and when the assist torque at the time of cutting-back is controlled as described above, return characteristics of the steering input means can be made natural approximately in conformity with the feeling of the driver. Note that although the last time value preferably means a previous time value, the last time value is not necessarily limited to the previous time value as long as the driver can be provided with a natural steering feeling or when it is determined that the previous time value is an abnormal value, and the like.

In still another aspect of the vehicle information processing device according to the present invention including a control means, when the estimated turning curvature of the provisional travel position is larger at the time of cut operation executed by the driver, the control means more increases a dumping control term or a friction torque control term of the assist torque (claim 10).

According to the aspect, since a larger turning curvature at the provisional travel position more increase the dumping control term or the friction torque control term at the time of cutting operation, it becomes difficult for steering operation of the driver to be reflected to a change of the steering angle. Accordingly, when a disturbance occurs in actual cutting operation, the vehicle can be suppressed from being staggered, so that a robust property to a sudden disturbance can be secured.

Note that the dumping control term is calculated based on a steering angular speed as one of steering inputs and the friction torque control term is determined based on the steering angle as one of the steering inputs. That is, although both of the dumping control term and the friction torque control term are the same in that they influence the steering feeling at the time of cutting operation, operation of the driver as a target is different. In view of the point, it is not necessary to execute any one of the dumping control term and the friction torque control term at all times and both of them may be appropriately controlled in cooperation with each other.

In still another aspect of the vehicle information processing device according to the present invention including a control means, further including an acquiring means configured to acquire a present position and a plurality of past positions of the vehicle, wherein the estimating means estimates a turning curvature of the vehicle at the present position based on the acquired present position and the plurality of past positions, and when a deviation between the estimated turning curvature of the provisional travel position and a turning curvature of the estimated present position is larger at the time of cut operation executed by the driver, the control means more increases a dumping control term or a friction torque control term of the assist torque (claim 11).

According to the aspect, since a larger deviation between the turning curvature at the provisional travel position and the turning curvature at the present position estimated likewise the aspect described above more increases the dumping control term or the friction torque control term at the time of cutting operation, it becomes difficult for the steering operation of the driver to be reflected to a change of the steering angle. Accordingly, when the disturbance occurs in the actual cutting operation, the vehicle can be suppressed from being staggered, so that the robust property to the sudden disturbance can be secured.

Note that, also in aspect, the dumping control term and the friction torque control term can be controlled to an increasing side in cooperation with each other.

In still another aspect of the vehicle information processing device according to the present invention including a control means, the vehicle includes at least one of a steering angle variable means capable of changing a relation between the steering input and a steering angle of a steering wheel and an assist torque supplying means capable of supplying assist torque for assisting steering torque of a driver, and the vehicle information processing device further comprises a control means configured to control at least one of the steering angle variable means and the assist torque supplying means based on a time change amount of the estimated turning curvature (claim 12).

According to the aspect, since the steering angle variable means or the assist torque supplying means is controlled based on a time change amount of the estimated turning curvature, the road information at the provisional travel position ahead of the present position can be reflected to the steering control of the vehicle at the present point of time, so that steering characteristics in conformity with the intention of the driver can be acquired and the control in conformity with the feeling of the driver can be executed.

In still another aspect of the vehicle information processing device according to the present invention including a control means, when a road surface friction coefficient is equal to or more than a predetermined value, the control means controls the assist torque (claim 13).

According to the aspect, when the assist torque supplying means is controlled, the assist torque control can be executed by restricting the assist torque control to a state in which an appropriate assist can be executed by setting a permission condition as to a road surface friction coefficient with a result that the control can be executed in more conformity with the feeling of the driver.

In still another aspect of the vehicle information processing device according to the present invention including a control means, when acceleration of the vehicle is within a predetermined range, the control means controls the assist torque (claim 14).

According to the aspect, when the assist torque supplying means is controlled, the assist torque control can be executed by restricting the assist torque control to the state in which the appropriate assist can be executed by setting a permission condition as to acceleration and deceleration with a result that the control can be executed in more conformity with the feeling of the driver.

In still another aspect of the vehicle information processing device according to the present invention including a control means, as a steering angular speed is smaller, the control means more increases the assist torque (claim 15).

According to the aspect, when the assist torque supplying means is controlled, in a region in which the steering angular speed is high and it is difficult to extract the intension of the driver, the appropriate assist control can be executed by restricting to the state in which the steering angular speed is low and the intention of the driver can be extracted by executing the control for reducing the assist torque.

Operation and other merit of the present invention will be clarified from embodiments explained next.

### BRIEF DESCRIPTION OF DRAWINGS

FIG. 1 is a schematic configuration view conceptually illustrating a configuration of a vehicle according to a first embodiment.

FIG. 2 is a basic model view of a guide bar model.

FIG. 3 is a conceptual view of a previously read position.

FIG. 4 is a flowchart of a previously read curvature estimating process.

FIG. 5 is a conceptual view of a previously read position calculating process.

FIG. 6 is a conceptual view of a previously read curvature calculating process.

FIG. 7 is a view exemplifying a transition of curvature per hour.

FIG. 8 is a flowchart of a steering wheel controlling process.

FIG. 9 is a control block diagram of steering wheel returning control.

FIG. 10 is a view exemplifying a time transition of a curvature ρ of a center of gravity and a previously read curvature ρ′in an executing process of the steering wheel returning control.

FIG. 11 is a flowchart of a steering wheel controlling process according to a second embodiment of the present invention.

FIG. 12 is a control block diagram of assist torque control executed in a steering wheel controlling process of FIG. 11.

FIG. 13 is a view exemplifying a transition per hour of a dumping control amount CAdmp in an executing process of assist torque control.

FIG. 14 is a schematic vehicle travel state view exemplifying an effect of the assist torque control.

FIG. 15 is a view exemplifying a transition per hour of a steering angular speed MA′ in the executing process of the assist torque control.

FIG. 16 is a control block diagram of friction simulated torque control according to a third embodiment of the present invention.

FIG. 17 is a view exemplifying a transition per hour of a friction simulated torque TAfric in an executing process of the friction simulated torque control.

FIG. 18 is a flowchart of a steering wheel controlling process according to a fourth embodiment of the present invention.

FIG. 19 is a conceptual view of a turn direction determination.

FIG. 20 is a view exemplifying an addition of symbol to a previously read locus in response to a previously read curvature in the turn direction determination.

FIG. 21 is a control block diagram of assist torque control.

FIG. 22 is a view exemplifying a time transition of assist torque in an executing process of the assist torque control.

FIG. 23 is an enlarged view illustrating an initial portion of the assist torque control in the time transition of the assist torque illustrated in FIG. 22.

FIG. 24 is a view exemplifying the time transition of the assist torque using torque differentiation compensation as a comparative example.

FIG. 25 is an enlarged view illustrating an initial portion of the assist torque control in the time transition of the assist torque illustrated in FIG. 24.

FIG. 26 is a view exemplifying the time transition of the assist torque using δ differentiation compensation as a comparative example.

FIG. 27 is an enlarged view illustrating an initial portion of the assist torque control in the time transition of the assist torque illustrated in FIG. 26.

FIG. 28 is a control block diagram of assist torque control in a fifth embodiment of the present invention.

FIG. 29 is a view exemplifying a time transition of assist torque in an executing process of the assist torque control.

FIG. 30 is an enlarged view illustrating an initial portion of the assist torque control in the time transition of the assist torque illustrated in FIG. 29.

FIG. 31 is a view exemplifying the time transition of the assist torque using torque differentiation compensation as a comparative example.

FIG. 32 is an enlarged view illustrating an initial portion of the assist torque control in the time transition of the assist torque illustrated in FIG. 31.

FIG. 33 is a view exemplifying the time transition of the assist torque using δ differentiation compensation as a comparative example.

FIG. 34 is an enlarged view illustrating an initial portion of the assist torque control in the time transition of the assist torque illustrated in FIG. 33.

FIG. 35 is a control block diagram of assist torque control in a sixth embodiment of the present invention.

FIG. 36 is a view exemplifying a time transition of assist torque in an executing process of the assist torque control.

FIG. 37 is an enlarged view illustrating an initial portion of the assist torque control in the time transition of the assist torque illustrated in FIG. 36.

FIG. 38 is a view exemplifying the time transition of the assist torque using torque differentiation compensation as a comparative example.

FIG. 39 is an enlarged view illustrating an initial portion of the assist torque control in the time transition of the assist torque illustrated in FIG. 38.

FIG. 40 is a view exemplifying the time transition of the assist torque using δ differentiation compensation as a comparative example.

FIG. 41 is an enlarged view illustrating an initial portion of the assist torque control in the time transition of the assist torque illustrated in FIG. 40.

FIG. 42 is a control block diagram of assist torque control in a seventh embodiment of the present invention.

FIG. 43 is a control block diagram of assist torque control in an eighth embodiment of the present invention.

FIG. 44 is a control block diagram of assist torque control in a ninth embodiment of the present invention.

### DESCRIPTION OF EMBODIMENTS

### Embodiments of Present Invention

Hereinafter, embodiments of the present invention will be explained appropriately referring to drawings.

### First Embodiment

### Configuration of Embodiment

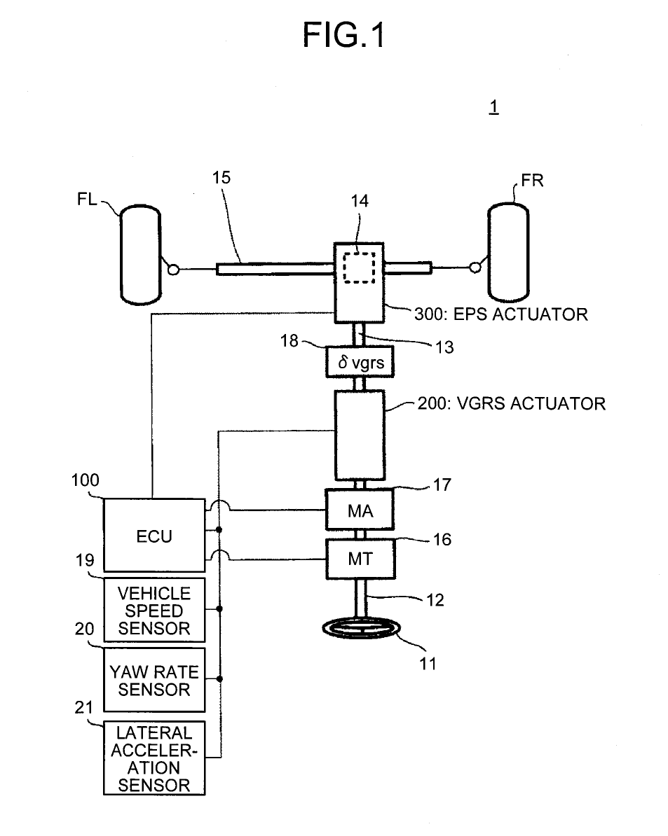

First, a configuration of a vehicle 1 according to a first embodiment of the present invention will be explained referring to FIG. 1. FIG. 1 is a schematic configuration view conceptually illustrating the configuration of the vehicle 1.

In FIG. 1, the vehicle 1 includes a pair of right and left front wheels FL and FR as steering wheels and is configured to be able to travel in a desired direction by rotating the front wheels. The vehicle 1 includes an ECU (Electronic Control Unit) 100, a VGRS actuator 200, and an EPS actuator 300.

The ECU 100 includes a CPU (Central Processing Unit), ROM (Read Only Memory), and RAM (Random Access Memory) each not illustrated, is an electronic control unit configured to be able to control operation of the vehicle 1 in its entirety, and is an example of a “vehicle information processing device” according to the present invention. The ECU 100 is configured to be able to execute a previously read curvature estimating process and a steering wheel controlling process as well as various controls accompanying the processes to be described later according to a control program stored in the ROM.

In the vehicle 1, a steering input applied from a driver via a steering wheel 11 is transmitted to an upper steering shaft 12 as a shaft body that is coupled so as to coaxially rotate with the steering wheel 11 and to be able to rotate in the same direction as the steering wheel 11. The upper steering shaft 12 functions as a steering input shaft to which the driver applies the steering input via the steering wheel. The upper steering shaft 12 is coupled with the VGRS actuator 200 in an end thereof on a downstream side.

The VGRS actuator 200 is a steering transmission ratio variable device as an example of “a steering angle variable means” according to the present invention. The VGRS actuator 200 has such a configuration that a VGRS motor is accommodated in a housing to which the end of the upper steering shaft 12 on the downstream side is fixed with the VGRS motor having a stator fixed in the housing likewise. Further, a rotor of the VGRS motor can rotate in the housing and is coupled with a lower steering shaft 13 as a steering output shaft in the housing via a speed reducing mechanism.

That is, in the VGRS actuator 200, the lower steering shaft 13 and the upper steering shaft 12 can rotate relatively with each other in the housing and can continuously change a steering transmission ratio which is a ratio between a steering angle MA as a rotation amount of the upper steering shaft 12 and a steering angle of a front wheel as a driven wheel that is unambiguously determined in response to a rotation amount of the lower steering shaft 13 within a predetermined range (the ratio is also related to a gear ratio of a rack and pinion mechanism to be described later) by controlling a drive of the VGRS motor via the ECU 100 and a not illustrated driving device.

The rotation of the lower steering shaft 13 is transmitted to the rack and pinion mechanism. The rack and pinion mechanism is a steering force transmitting mechanism including a pinion gear 14 connected to an end of the lower steering shaft 13 on the downstream side and a rack bar 15 to which a gear tooth to be meshed with a gear tooth of the pinion gear are formed, and a steering force is transmitted to respective steering wheels via a tie rod and a knuckle (reference numerals omitted) coupled with both ends of the rack bar 15 by converting a rotation of the pinion gear 14 to a motion in a right-left direction of the rack bar 15 in the figure. That is, in the vehicle 1, a so-called rack and pinion type steering system is realized.

The EPS actuator 300 is an electrically driven power steering device as an example of “an assist torque supplying means” according to the present invention including an EPS motor as a DC brushless motor having a not illustrated rotor as a rotator to which a permanent magnet is attached and a stator surrounding the rotor. The EPS motor is configured to be able to generate an assist torque TA in a rotating direction of the rotor by rotating the rotor by action of a rotating magnetic field formed in the EPS motor by the energization of the stator via a not illustrated EPS driving device.

In contrast, a motor shaft as a rotating shaft of the EPS motor is fixed with a not illustrated speed reduction gear which is also meshed with the pinion gear 14. Accordingly, the assist torque TA generated from the EPS motor functions as assist torque for assisting a rotation of the pinion gear 14. The pinion gear 14 is coupled with the lower steering shaft 13 as described above, and the lower steering shaft 13 is coupled with the upper steering shaft 12 via the VGRS actuator 200. Accordingly, a driver steering torque MT applied to the upper steering shaft 12 is transmitted to the rack bar 15 while being appropriately assisted by the assist torque TA, so that a steering load of the driver is reduced. Note that an operating direction of the assist torque TA is a direction opposite to the driver steering torque MT, the assist torque TA naturally acts in a direction where the steering operation of the driver is obstructed.

The vehicle 1 is provided with various sensors including a steering torque sensor 16, a steering angle sensor 17, a VGRS relative angle sensor 18, a vehicle speed sensor 19, a yaw rate sensor 20, and a lateral acceleration sensor 21.

The steering torque sensor 16 is a sensor configured to be able to detect the driver steering torque MT applied from the driver via the steering wheel 11.

To explain more specifically, the upper steering shaft 12 has such a configuration that it is divided to an upstream portion and a downstream portion which are coupled with each other by a not illustrated torsion bar. Rotation phase difference detection rings are fixed to both ends of the torsion bar on an upstream side and on a downstream side. The torsion bar is configured such that it is twisted in a rotating direction of the steering wheel 11 in response to steering torque (that is, the driver steering torque MT) transmitted via the upstream portion of the upper steering shaft 12 when the driver of the vehicle 1 operates the steering wheel 11 and can transmit the steering torque to the downstream portion while generating the twist. Accordingly, when the steering torque is transmitted, a rotation phase difference is generated between the rotation phase difference detection rings described above. The steering torque sensor 16 is configured to be able to detect the rotation phase difference as well as to be able to change the rotation phase difference to the steering torque and to be able to output the steering torque as an electric signal corresponding to the steering torque MT. Further, the steering torque sensor 16 is electrically connected to the ECU 100 and the detected steering torque MT is referred to by the ECU 100 at a definite or indefinite cycle.

The steering angle sensor 17 is an angle sensor configured to be able to detect the steering angle MA that shows the rotation amount of the upper steering shaft 12. The steering angle sensor 17 is electrically connected to the ECU 100, and the detected steering angle MA is referred to by the ECU 100 at a definite or indefinite cycle. Note that the ECU 100 is configured to calculate a steering angular speed MA′ by subjecting the detected steering angle MA to a time differentiating process. The steering angle MA and the steering angular speed MA′ are an example of “steering input information” according to the present invention.

The VGRS relative angle sensor 18 is a rotary encoder configured to be able to detect a VGRS relative rotation angle δVGRS as a rotation phase difference between the upper steering shaft 12 and the lower steering shaft 13 in the VGRS actuator 200. The VGRS relative angle sensor 18 is electrically connected to the ECU 100, and the detected VGRS relative rotation angle δVGRS is referred to by the ECU 100 at a definite or indefinite cycle.

The vehicle speed sensor 19 is a sensor configured to be able to detect a vehicle speed V as a speed of the vehicle 1. The vehicle speed sensor 19 is electrically connected to the ECU 100, and the detected vehicle speed V is referred to by the ECU 100 at a definite or indefinite cycle.

The yaw rate sensor 20 is a sensor configured to be able to detect a yaw rate Yr of the vehicle 1. The yaw rate sensor 20 is electrically connected to the ECU 100, and the detected yaw rate Yr is referred to by the ECU 100 at a definite or indefinite cycle.

The lateral acceleration sensor 21 is a sensor configured to be able to detect lateral acceleration Gy as the speed of the vehicle 1. The lateral acceleration sensor 21 is electrically connected to the ECU 100, and the detected lateral acceleration Gy is referred to by the ECU 100 at a definite or indefinite cycle.

### Operation of Embodiment

Hereinafter, as operations of the embodiment, a previously read curvature estimating process and a steering wheel controlling process will be explained in detail.

Outline of Guide Bar Model

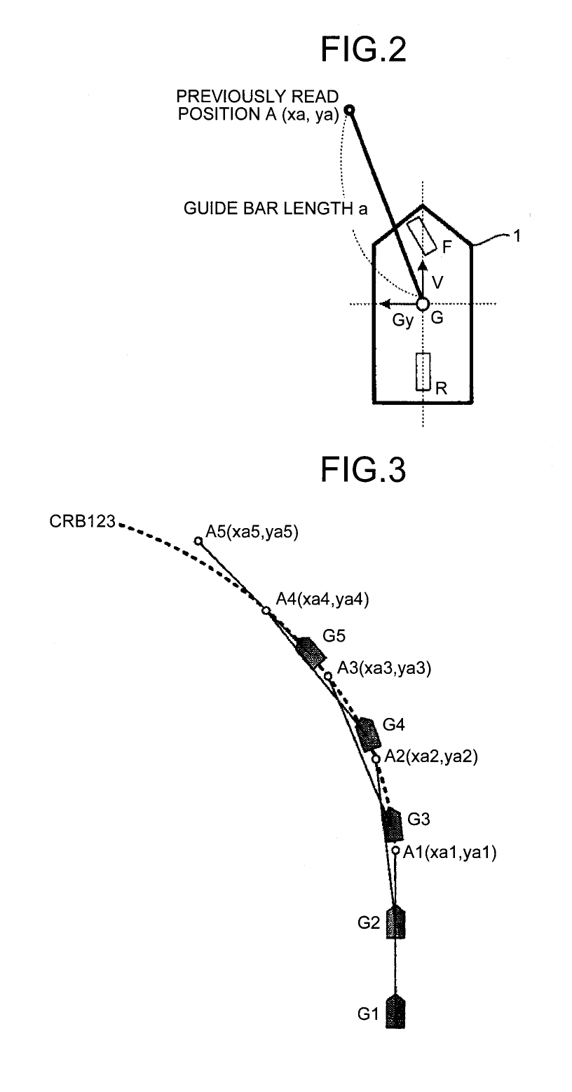

First, an outline of a guide bar model as a calculation model used for a previously read curvature estimating process will be explained referring to FIG. 2. FIG. 2 is a basic model view of the guide bar model. Note that, in the figure, the portions duplicating those of FIG. 1 are denoted by the same symbols and the explanation thereof is appropriately omitted. Note that the guide bar model is a calculation model constructed to predict a future position of a vehicle based on steering input information, a vehicle state amount, and a vehicle speed from past to a present point of time from a standpoint that (1) a steering input of a driver shows a direction from a present position of the vehicle to a target reach position and a target travel direction when a target reach position is reached and (2) a vehicle speed shows a distance from a present position of the vehicle to the target reach position when a present travel direction of the vehicle is used as a reference.

In FIG. 2, it is assumed that the vehicle 1 has a front wheel F and a rear wheel R on a center line passing through a center of gravity G in a front-back direction, and a guide bar (refer to a white circle), which extends from the center of gravity G, has a length a, and an extreme end portion (refer to a thick line) illustrating a future position of the center of gravity G, is set. A position of the extreme end portion of the guide bar is a previously read position A (xa, ya). Note that (xa, ya) are a relative coordinate of the previously read position A in a secondary coordinate system constructed for the purpose of convenience.

Next, how a vehicle position is previously read by the guide bar will be conceptually explained referring to FIG. 3. FIG. 3 is a conceptual view of a previously read position.

In FIG. 3, when it is assumed that the vehicle 1 travels at a position illustrated by G1, a previously read position with respect to the vehicle position G1 that can be acquired by an arithmetic operating process to be described later based on the guide bar model is illustrated as a previously read position A1 (xa1, ya1) illustrated in the figure. Likewise, previously read positions A2 (xa2, ya2), A3 (xa3, ya3), A4 (xa4, ya4), and A5 (xa5, ya5) are set with respect to the vehicle positions of G2, G3, G4, and G5 illustrated in the figure.

In contrast, for example, in the previously read positions, CRB123 (refer to a broken line) that can be acquired by connecting the previously read positions A1, A2, and A3 becomes one of previously read loci as a locus of a provisional travel position that precedes on a time axis with respect to the present position of the vehicle 1. An inverse number of a radius R of the previously read locus is a previously read curvature ρ′ and becomes an important element when a steering feeling to be applied to the driver is determined.

To provide an additional explanation, an increase of the vehicle speed causes the driver to execute steering operation with a viewpoint put farther (that is, the guide bar length a becomes longer). Accordingly, in steering control based on a turning curvature at the present position (for example, control of the assist torque TA by the EPS), an increase of the vehicle speed may cause a steering feeling to be more deviated from an expected value anticipated by the driver except some statuses such as a straight travel and a steady circular turn. Note that the problem cannot be avoided in many cases even if a road curvature ahead of the present position is found. This is because a road curvature does not coincide with a turning curvature of a vehicle in response to steering operation of the driver to no small extent.

Thus, the ECU 100 is configured to estimate a turning curvature of the vehicle 1 at a provisional travel position ahead of the present position (that is deemed to be reached in future) by the previously read curvature estimating process and to control the EPS actuator 300 based on the estimated turning curvature.

Detail of Previously Read Curvature Estimating Process

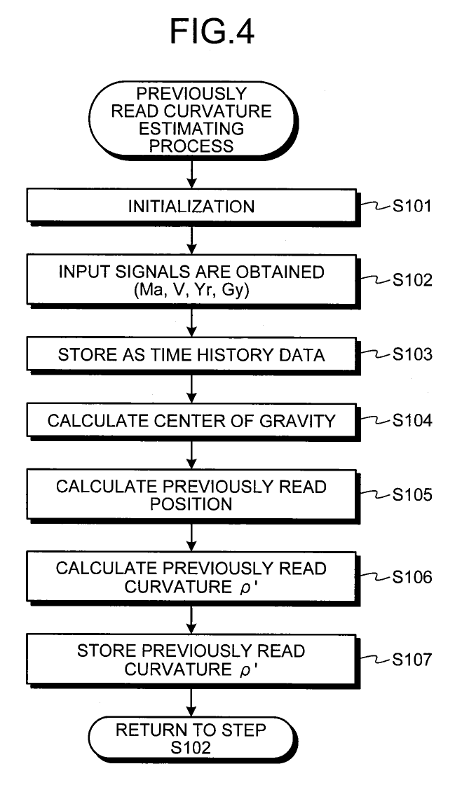

The previously read curvature estimating process will be explained in detail referring to FIG. 4. FIG. 4 is a flowchart of the previously read curvature estimating process.

In FIG. 4, the ECU 100 initializes respective variables (step S101). Note that the variables are initialized only at the first time.

When the variables have been initialized, various input signals (that is, the reference element group described above) necessary to estimate the previously read curvature ρ′ are acquired. Specifically, the steering angle MA, the vehicle speed V, the yaw rate Yr, and the lateral acceleration Gy until the past a predetermined time ahead of the present point of time are acquired (step S102). Note that, in the embodiment, although all of them are detected by corresponding sensors, for example, the yaw rate Yr and the lateral acceleration Gy may be estimated from the vehicle speed V and the steering angle MA. The estimation method has been known.

Subsequently, a time history data in which the thus acquired input signals are arranged in time series is temporarily stored in the RAM (step S103).

When the time history data has been stored, the ECU 100 calculates a center of gravity of the vehicle 1 (step S104). Note that it means that a coordinate of the center of gravity is determined to calculate the center of gravity. However, the coordinate is not an absolute coordinate determined from, for example, latitude, longitude, and the like but may be a relative position coordinate with respect to a reference position (that is, may be a change amount from the reference position).

A calculating process of the center of gravity according to step S104 will be explained.

At step S104, first, a vehicle body slip angle β is determined based on Expression (2) derived from a relation illustrated in Expression (1). Note that dβ means a time differential value of the vehicle body slip angle β.

Gy=V×(dβ+YR) (1)

β=·{(Gy−YR×V)/V}dt (2)

In contrast, a yaw angle YA of the vehicle 1 is determined by Expression (3).

YA=∫(YR)dt (3)

A locus of the center of gravity (time locus) is shown as Expression (4) and Expression (5) therefrom. Note that X is a locus drawn by an x-coordinate of the center of gravity and Y is a locus drawn by a y-coordinate likewise. A present value of the center of gravity is a value corresponding to a present time of the locus, and when the present time is illustrated by t, the present value of the center of gravity is illustrated by (x(t), y(t)).

X=−∫{sin(β+YA)*V}dt (4)

Y=∫{cos(β+YA*V)}dt (5)

When the center of gravity is determined, the ECU 100 calculates a previously read position (step S105). A calculating process of the previously read position will be explained referring to FIG. 5. FIG. 5 is a conceptual view of the previously read position calculating process. Note that, in the figure, the portions duplicating those of the figures already explained are denoted by the same symbols and the explanation thereof is appropriately omitted.

In FIG. 5, a straight line L1 is set based on a present value of the locus of the center of gravity, that is, based on a center of gravity B(x(t), y(t)) at the present point of time and a vehicle center of gravity C (x(t−1), y(t−1)) ahead of one sampling time (that is, a time in the past a last time value reference time tb ahead of a present time t). An extreme end position of the guide bar described above is calculated as a previously read position from the steering angle MA and the vehicle body slip angle β using the straight line L1 have been set as a reference.

A specific calculating process of the previously read position will be explained here.

Specifically, first, based on a known way of thinking of an exterior division, an exterior division point A′(x(a′), y(a′)) illustrated in the figure is calculated from the center of gravity B and the center of gravity C according to Expression (6), Expression (7), and Expression (8). Note that, in Expressions (6), (7), and (8), n is a distance between the center of gravity B and the exterior division point A′ and m is a distance between the center of gravity B and the center of gravity C. Further, δ is a steering angle of the front wheel as the steering wheel. The steering angle δ is a value acquired by dividing the steering angle MA by a steering gear ratio and determined by arithmetic operation.

n=a×cos(δ+β) (6)

m=√{(x(t)−x(t−1))²+(y(t)−y(t−1))²} (7)

A′(x(a′),y(a′))={((x(t)×(m+n)−n×x(t−1))/m),((y(t)×(m+n)−n×y(t−1))/m)} (8)

Next, an equation of the straight line L1 is determined from the center of gravity B (x(t), y(t)) and the center of gravity C(x (t−1), y(t−1)) according to Expressions (9) to (13).

y(t)=a1×x(t)+b1 (9)

y(t−1)=a1×x(t−1)+b1 (10)

y(t)−y(t−1)=a1×{x(t)−x(t−1)} (11)

a1={y(t)−y(t−1)}/{x(t)−x(t−1)} (12)

b1=y(t)−a1×x(t) (13)

Next, an equation of a straight line when the straight line L1 passing through the center of gravity B is rotated by a rotation angle (δ+β) is determined from Expressions (14), (15).

y(t)={a1+sin(δ+β)}×x(t)+b2 (14)

b2=y(t)−a1×x(t)−x(t)×sin(δ+β) (15)

The y-coordinate y (a) of the previously read position is shown by Expression (16).

y(a)={a1+sin(δ+β)}×x(a)+b2 (16)

Further, Expression (17) is established by Pythagorean theorem.

√{(x(a)−x(a′))²+(y(a)−y(a′))²}²+√{(x(a′)−x(t))²+(y(a′)−y(t))²}²=[√{(x(a)−x(t))²+(y(a)−y(t))²}]² (17)

When simultaneous equations composed of Expression (16) and Expression (17) are solved, the x-coordinate x (a) of the previously read position is determined as shown in Expression (18).

x(a)={−y(a′)×y(t)+x(a′)²+y(a′)²−x(a′)×x(t)−b2×y(a′)+b2×y(t)}/{x(a′)−x(t)+y(a′)×a1+y(a′)×sin(δ+β)−y(t)×a1−y(t)×sin(δ+β)} (18)

When Expression (18) is substituted for Expression (16), the y-coordinate y (a) of the previously read position is also determined as shown in Expression (19).

y(a)={a1+sin(δ+β)}×x(a)+b2 (19)

The previously read position A(x(a), y(a)) is estimated as described above. Actually, the respective formulae for computation necessary to estimate the previously read position A are previously stored in the storage device such as the ROM and the like as fixed values, and the ECU 100 is configured to calculate the previously read position based on the acquired input signals appropriately referring to the fixed values.

Returning to FIG. 4, when the previously read position has been calculated, the ECU 100 calculates the previously read curvature ρ′ (step S106) and stores the thus calculated previously read curvature ρ′ as the previously read curvature ρ′(t) corresponding to the present time (step S107), and when the previously read curvature ρ′(t) has been stored, the process is returned to step S102, and a series of process is repeated. The previously read curvature estimating process proceeds as described above. Note that each time the previously read curvature ρ′(t) is calculated, a sample value ahead of one sampling time is stored with accompanying time information moved back one sampling time as shown by ρ′(t−1).

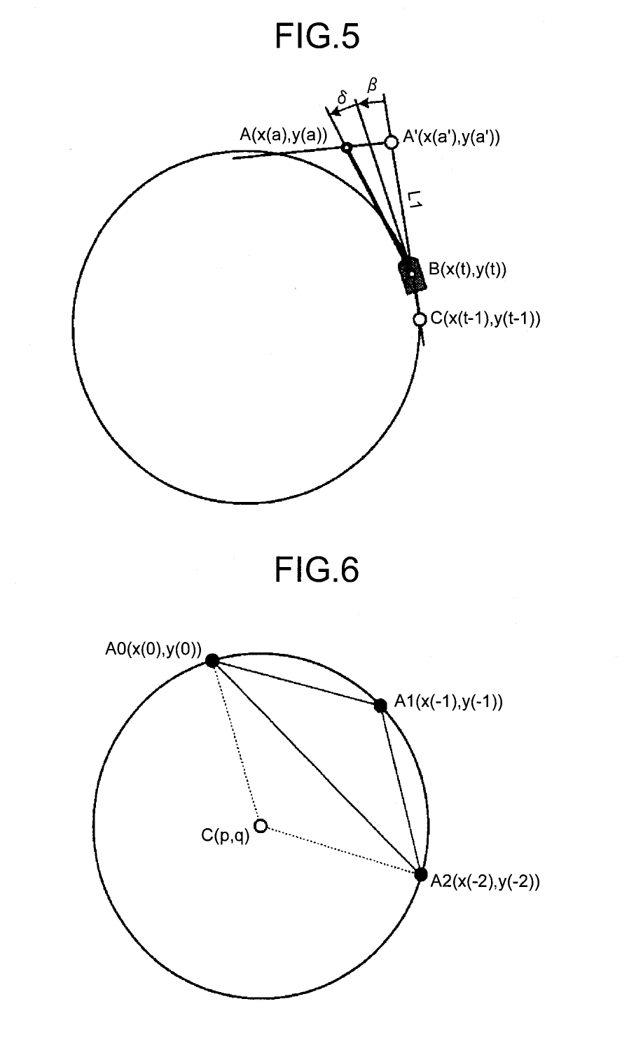

A calculating process of the previously read curvature ρ′ according to step S106 will be explained referring to FIG. 6. FIG. 6 is a conceptual view of the previously read curvature calculating process.

In FIG. 6, in the previously read loci which have been determined by connecting the previously read positions that are previously determined, a previously read position A0 (x(0), y(0)) as a latest previously read position (that is, a previously read position corresponding to the present position), a once past previously read position A1 (x(−1), y(−1)) as a previously read position ahead of one sampling time (that is, a previously read position corresponding to a past position), and a twice past previously read position A2 (x(−2), y(−2)) as a previously read position ahead of two sampling times (that is, a previously read position corresponding to a past position) will be examined. From the three previously read positions, a center coordinate (p, q) of an imaginary circle drawn by previously read loci and a radius R thereof are determined. Note that the once past previously read position A1 and the twice past previously read position A2 are also vehicle positions ahead of the present position likewise the previously read position A0 (that is, to which the vehicle has not yet reached).

First, Expression (20) is established from a formula of circle.

(x−p)²+(y−q)²=R² (20)

A substitution of the coordinates of the respective previously read positions for Expression (20) establishes Expression (21), Expression (22), and Expression (23).

Note that, for the convenience of explanation, in Expressions (21) to (30), a negative symbol is omitted from Expressions of the once past previously read position A1 and the twice past previously read position A2.

(x(0)−p)²+(y(0)−q)²=R² (21)

(x(1)−p)²+(y(1)−q)²=R² (22)

(x(2)−p)²+(y(2)−q)²=R² (23)

Further, when Expressions described above are developed, Expressions (24), (25), and (26) are established.

p²−2×x(0)×p+x(0)²+q²+2×y(0)q+y(0)²=R² (24)

p²−2×x(1)×p+x(1)²+q²+2×y(1)q+y(1)²=R² (25)

p²−2×x(2)×p+x(2)²+q²+2×y(2)q+y(2)²=R² (26)

When simultaneous equations composed of Expressions (24), (25), and (26) are solved, center coordinates p and q of an imaginary circle formed by the previously read loci and a radius R thereof are calculated by Expressions (27), (28), and (29).

$$\begin{matrix}p = [ 1 / \{ 2 \times ( y ( 1 ) \times x ( 0 ) - x ( 0 ) \times y ( 2 ) - x ( 1 ) \times y ( 1 ) - x ( 1 ) \times y ( 0 ) + x ( 2 ) \times y ( 0 ) + y ( 2 ) \times x ( 1 ) ) \} ] \times ( - y ( 0 ) \times {x ( 1 )}^{2} + y ( 2 ) \times {x ( 1 )}^{2} + {x ( 2 )}^{2} \times y ( 0 ) + {y ( 1 )}^{2} \times y ( 2 ) - {y ( 1 )}^{2} \times y ( 0 ) - y ( 2 ) \times {x ( 0 )}^{2} - y ( 1 ) \times {y ( 2 )}^{2} + {x ( 0 )}^{2} \times y ( 1 ) + {y ( 0 )}^{2} \times y ( 1 ) + {y ( 2 )}^{2} \times y ( 0 ) - {x ( 2 )}^{2} \times y ( 1 ) - y ( 2 ) \times {y ( 0 )}^{2} ) & ( 27 ) \\ q = [ 1 / \{ 2 \times ( y ( 1 ) \times x ( 0 ) - x ( 0 ) \times y ( 2 ) - x ( 2 ) \times y ( 1 ) - x ( 1 ) \times y ( 0 ) + x ( 2 ) \times y ( 0 ) + y ( 2 ) \times x ( 1 ) ) \} ] \times ( {x ( 0 )}^{2} \times x ( 1 ) - {x ( 0 )}^{2} \times x ( 2 ) - {x ( 1 )}^{2} \times x ( 0 ) - {y ( 1 )}^{2} \times x ( 0 ) + x ( 0 ) \times {x ( 2 )}^{2} + x ( 0 ) \times {y ( 2 )}^{2} + {y ( 0 )}^{2} \times x ( 1 ) - x ( 2 ) \times {y ( 0 )}^{2} - {x ( 2 )}^{2} \times x ( 1 ) + x ( 2 ) \times {x ( 1 )}^{2} + x ( 2 ) \times {y ( 1 )}^{2} - {y ( 2 )}^{2} \times x ( 1 ) ) & ( 28 ) \\ R = \sqrt{ } ( {x ( 0 )}^{2} - 2 \times x ( 0 ) \times p + {p}^{2} + {y ( 0 )}^{2} - 2 \times y ( 0 ) \times q + {q}^{2} ) & ( 29 )\end{matrix}$$

Accordingly, the previously read curvature ρ′ is finally shown by Expression (30).

ρ′=1/R=1/√{(x(0)−p)²+(y(0)−q)²} (30)

Note that when the previously read curvature ρ′ of the vehicle 1 at a previously read position is determined, it is sufficient to substitute a coordinate (x(a), y(a)) in response to a desired previously read position for x(0) and y(0) of Expression (30). Likewise, as to a turning curvature ρ of the vehicle 1 at the present position, it is sufficient to substitute a coordinate (x(t), y(t)) in response to a center of gravity at the present point of time for x(0) and y(0) of Expression (30).

Note that although the previously read position A0 (x(0), y(0)), the once past previously read position A1 (x(−1), y(−1)), and the twice past previously read position A2 (x(−2), y(−2)) any of which is the previously read position are examined, the previously read curvature ρ′ can be estimated likewise based on at least three vehicle positions including a previously read position and a present position or a previously read position estimated based on the present position (here, the previously read position A0) (that is, the previously read position A0 is a vehicle position satisfying both conditions).

A combination of vehicle positions provided to estimate the previously read curvature ρ′ will be exemplified below in A to E (since it is sufficient that at three points are provided, the combinations exemplified here show only the cases in which three points are provided). Note that, also in the following examples, there are contemplated cases including and not including a previously read position corresponding to a present position as a previously read position (the above example is a case including the previously read position as well as a case in which three points which continue with each other on a time series are selected, and when the previously read position corresponding to the present position is not included, the present position is included as the reference element. Although any of processes relating to the estimation of the previously read curvature is the same, since the present position or the previously read position corresponding to the present position correlates with the present position as an actual phenomenon, the previously read curvature ρ′ is estimated with high accuracy by that at least three vehicle positions including at least the present position and the previously read position corresponding to the present position are referred to.

(A) previously read position×3(above example)
(B) previously read position×2+present position
(C) previously read position×2+past position×1
(D) previously read position×1+present position+past position×1
(E) previously read position×1+past position×2

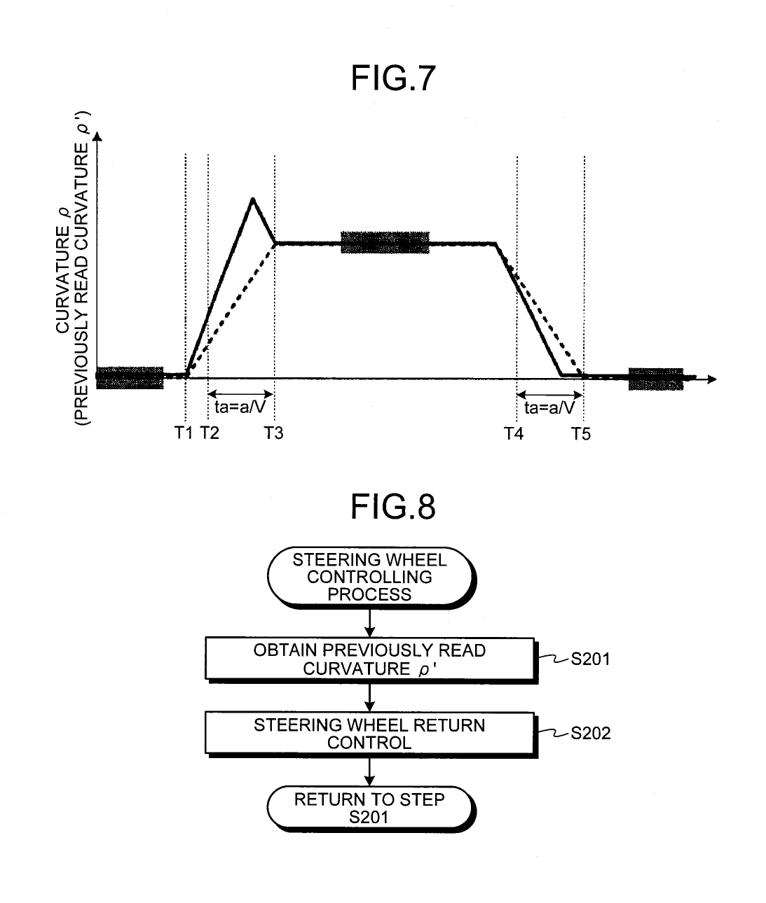

A difference between the previously read curvature ρ′ and the curvature ρ at the center of gravity will be visually explained here referring to FIG. 7. FIG. 7 is a view exemplifying a transition per hour of a curvature.

In FIG. 7, a solid line illustrates a time transition of the previously read curvature ρ′ and a broken line shows the curvature ρ at a center of gravity.

In a time domain before a time T1 (hatched portion), the vehicle 1 travels straight, and when the vehicle 1 approaches a curved road at the time T1, the previously read position A begins to be estimated as described above. When a previously read time ta (ta=V/a) is defined by setting a time T2 as a present time (present point of time) for the purpose of convenience, the driver already executes steering operation at the time T2 expecting a travel position to which the vehicle 1 will reach at a time T3 (T3=T2+ta) (an example of “the provisional travel position” according to the present invention).

At the time T3, a curvature of the road becomes constant and the vehicle 1 is converged to a steady circular turning state, the previously read curvature ρ′ coincides with the curvature ρat the center of gravity again (refer to the hatched region).

When the curved road begins to return to the straight road, the previously read curvature ρ′ begins to be deviated from the curvature ρ again, and at, for example, a time T4, the driver executes steering operation expecting a travel position to which the vehicle 1 will reach at a time T5 (T5=T4+ta) (an example of “the provisional travel position” according to the present invention). In a transient region in which the previously read curvature ρ′ is deviated from the curvature ρ at the center of gravity, when steering control according to the curvature ρ at the center of gravity is executed, a steering feeling provided with the driver is deviated from a feeling of the driver to thereby cause an uncomfortable feeling. To cope with the problem, in the embodiment, the steering wheel controlling process is executed by the ECU 100. In the steering wheel controlling process, cut back torque TArev (a part of the assist torque) at the time of cut back of the steering wheel is controlled based on the estimated previously read curvature ρ′.

The steering wheel controlling process will be explained in detail referring to FIG. 8. FIG. 8 is a flowchart of the steering wheel controlling process.

In FIG. 8, the ECU 100 acquires the previously read curvature ρ′ estimated in the previously read curvature estimating process (step S201). When the previously read curvature ρ′ has been acquired, the steering wheel returning control is executed (step S202). When the steering wheel returning control has been executed, the process is returned to step S201 and a series of process is repeated. The steering wheel controlling process proceeds as described above.

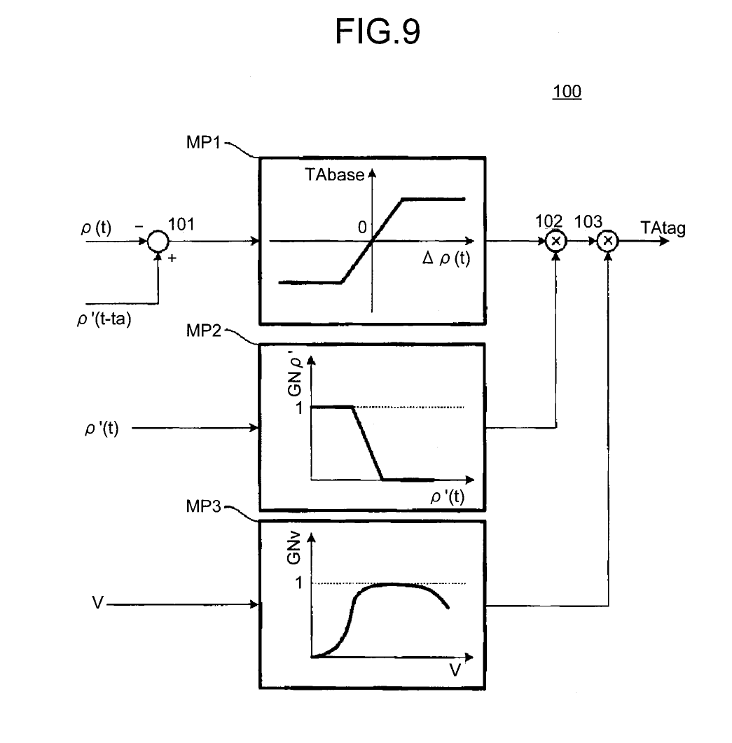

The steering wheel returning control according to step S202 will be explained in detail referring to FIG. 9. FIG. 9 is a control block diagram of the steering wheel returning control. Note that, in the figure, the portions duplicating those of the figures already explained are denoted by the same symbols and the explanation thereof is appropriately omitted.

In FIG. 9, when the steering wheel returning control is executed, the ECU 100 calculates a target value of the assist torque TA making use of calculators 101, 102, and 103 as well as control maps MP1, MP2, and MP3. When the target value is calculated, the EPS actuator 300 is controlled in response to the target value as described already. More specifically, the target value TAtag of the assist torque TA is shown as Expression (31) by the actions of the calculator 102 and the calculator 103 as multipliers.

TAtag=TAbase×GNρ′×GNv (31)

In Expression (31), TAbase is basic assist torque giving a reference to the assist torque and set by the control map MP1. Further, gains GNp and GNv are a curvature gain and a vehicle speed gain, respectively and set by the control maps MP2 and MP3, respectively.

The control map MP1 is a map for causing a first curvature deviation Δρ(t) to correspond to the basic assist torque TAbase. The ECU 100 calculates the first curvature deviation Δρ(t) by the calculator 101 and selects a corresponding value from the control map MP1 based on the calculated first curvature deviation Δρ(t). Note that the first curvature deviation Δρ(t) is a difference between the curvature ρ(t) at the present position and a last time value ρ′(t−ta) of the previously read curvature and shown by Expression (32). The first curvature deviation Δρ(t) is a deviation between a previously read curvature (ρ′(t−ta)) at the time before one sample at which a time t was a previously read time and the curvature ρ(t) of the center of gravity at the time t and a deviation between, for example, a value corresponding to a solid line and a value corresponding to a broken line at the time T2 referring to FIG. 7.

Δρ(t)=ρ′ (t−ta)−ρ(t) (32)

In the control map MP1, a region on a lower side of an origin means a region of steering wheel return torque acting in a cut back direction, and a region on an upper side of the origin means a region of assist torque acting in a cut direction. That is, when a last time value ρ′(t−ta) of the previously read curvature in which the first curvature deviation Δρ(t) employs a negative value is smaller than the curvature ρ(t) at the present position, in other words, when the vehicle enters from a curved road to a straight road, and the like, the basic assist torque TAbase acting in a steering wheel cut back direction is set. In contrast, in the control map MP1, when the last time value ρ′(t−ta) of the previously read curvature in which the first curvature deviation Δρ(t) employs a positive value is larger than the curvature ρ(t) at the present position, in other words, when the vehicle enters from a straight road to a curved road, and the like, the basic assist torque TAbase acting in a steering wheel cut direction is set.

The control map MP2 is a map for causing the previously read curvature ρ′(t) to correspond to a curvature gain GNρ′. The ECU 100 is configured to select a corresponding value from the control map MP2 in response to the previously read curvature ρ′(t). The control map MP2 is configured such that the curvature gain GNρ′ becomes zero to the previously read curvature ρ′(t) equal to or more than the reference value. Accordingly, even if the basic assist torque TAbase is set in the cut direction by the control map MP1, the basic assist torque TAbase does not contribute to setting of the assist torque TAtag except when the previously read curvature ρ′(t) in which the curvature gain GNρ′ employs “1” employs a minimum value less than the reference value by using the control map MP2 together. That is, since the previously read curvature ρ′(t) can be reflected to the assist torque TA only at the time of cut back, a natural steering feeling can be realized without greatly affecting steering operation of the driver.

In contrast, the control map MP3 is a map for causing the vehicle speed V to correspond to the vehicle speed gain GNv. The ECU 100 is configured to select a corresponding value from the control map MP3 in response to the vehicle speed V. Since the control map MP3 is configured to set the vehicle speed gain GNv to “1” only in a medium and high vehicle speed region, control of the assist torque TA in response to the previously read curvature ρ′(t) is executed mainly only in the medium and high vehicle speed region. In a low vehicle speed region, since the guide bar length a becomes short, no large difference is generated between a curvature which is reflected to steering operation by the driver and a curvature at the present position. Accordingly, a necessity for improving a steering feeling does not originally occur.

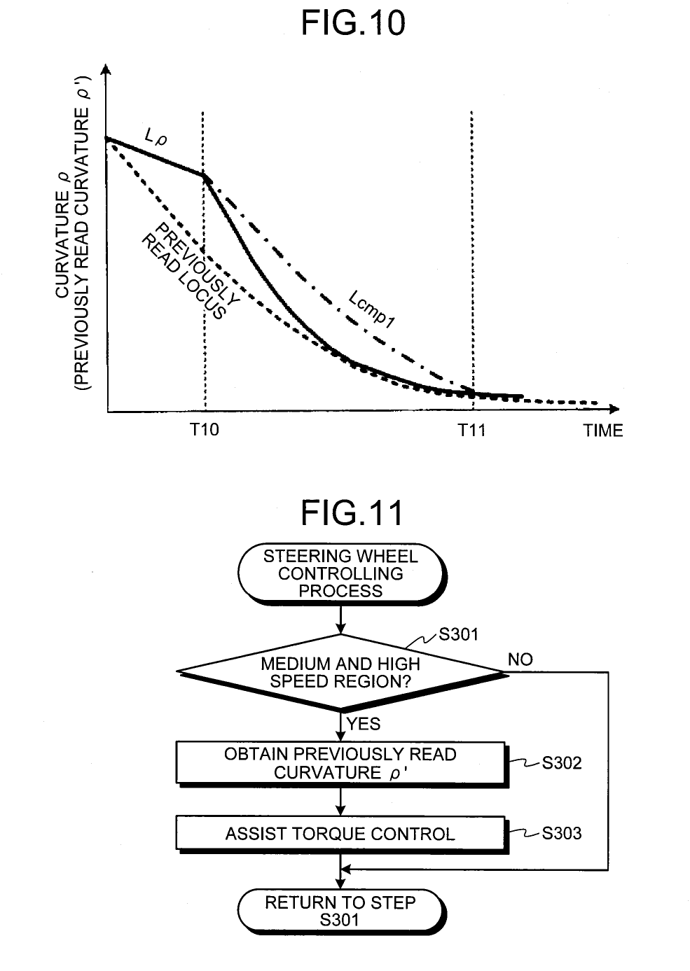

An effect of the steering wheel returning control will be explained referring to FIG. 10. FIG. 10 is a view exemplifying a time transition of the curvature ρ of the center of gravity and the previously read curvature ρ′ in an executing process of the steering wheel returning control.

In FIG. 10, a locus of the previously read curvature ρ′ is illustrated by a broken line. In contrast, a locus of the curvature ρ of the center of gravity of the actual vehicle 1 is illustrated Lρ (solid line).

As illustrated in the figure, when the steering wheel returning control is started at a time T10, since a deviation between the curvature ρ(t) at the vehicle position at the time T10 and the last time value ρ′(t−ta) of the previously read curvature ρ′ is large, the large assist torque TA what is relatively large is acted in the cut back direction by the action of the control map MP1 described above, so that the curvature ρ(t) of the vehicle 1 is relatively steeply reduced. The assist torque TA is applied in the cut back direction in a feedback control fashion to converge the first curvature deviation Δρ(t) to zero, so that the deviation between the curvature ρ(t) of the center of gravity and the last time value ρ′(t−ta) of the previously read curvature is smoothly reduced.

In contrast, a locus Lcmp1 is illustrated by a dot-dash line as a comparative example to be compared with the embodiment. Since Lcmp1 copes with a case that the assist torque TA is controlled based only on the curvature ρ(t) at the present position at all times, the previously read curvature ρ′(t) is not reflected to the control at all. Accordingly, during a period until a travel road is returned to a straight road at a time T11, the curvature ρ(t) of the center of gravity is deviated from the last time value ρ′(t−ta) of the previously read curvature at all times. Accordingly, the feeling of the driver is not matched with a return speed of the steering wheel 11 or with a response when return speed operation of the steering wheel 11 is executed, so that the steering feeling becomes uncomfortable to the driver.

As described above, according to the steering wheel returning control according to the embodiment, the assist torque TA in response to the previously read curvature ρ′(t) is generated in the cut back direction at the time of cut back operation in which the previously read curvature is reduced at the future position of the vehicle 1. Accordingly, the feeling of the driver is matched with the return speed of the steering wheel 11 or with the response when the return speed operation of the steering wheel 11 is executed, so that a steering feeling that is natural to the driver is realized.

### Second Embodiment

In the first embodiment, although the previously read curvature ρ′(t) is reflected to the control of the assist torque TA when the steering wheel is cut back, in a second embodiment, the assist torque TA at the time of cut is controlled based on the previously read curvature ρ′(t). First, a steering wheel controlling process according to the second embodiment will be explained referring to FIG. 11. FIG. 11 is a flowchart of the steering wheel controlling process.

In FIG. 11, first, whether or not a vehicle speed V corresponds to a medium and high speed region is determined (step S301). Note that “the medium and high speed region” is a vehicle speed region in which it is unlikely that a comfortable steering feeling is provided with a driver by control based on a curvature ρ(t) at a center of gravity at a present point of time likewise the first embodiment. When the vehicle speed V does not correspond to the medium and high vehicle speed region (step S301: NO), the process is placed in a substantially waiting state at step S301.

When the vehicle speed V of the vehicle 1 corresponds to the medium and high vehicle speed region (step S301: YES), the ECU 100 acquires the previously read curvature ρ′ (step S302) and executes assist torque control based on the acquired previously read curvature ρ′ (step S303). When the assist torque control has been executed, the process is returned to step S301, and a series of process is repeated.

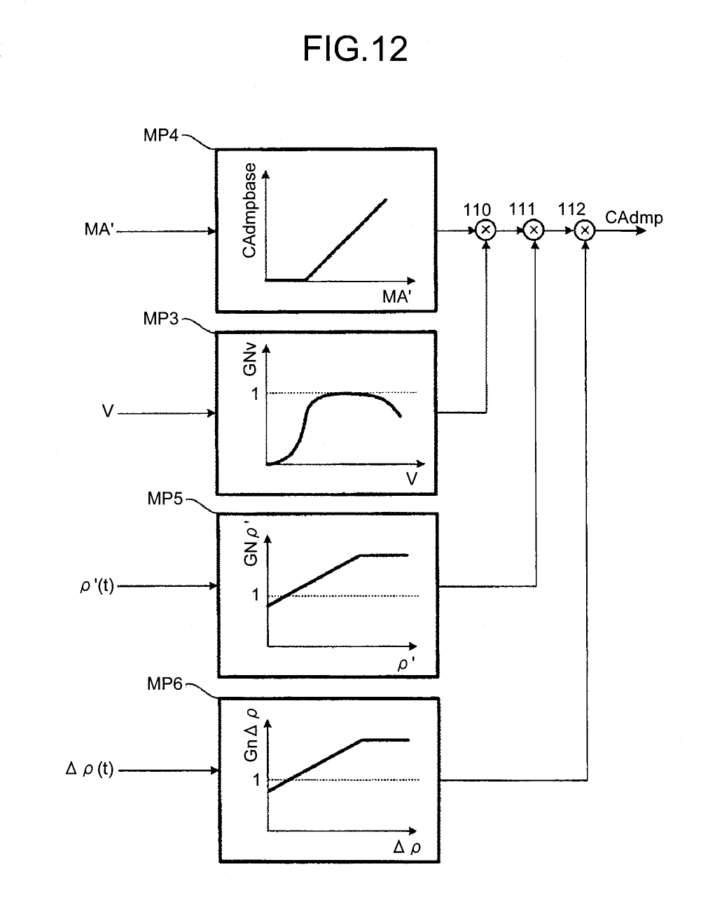

The assist torque control will be explained in detail referring to FIG. 12. FIG. 12 is a control block diagram of the assist torque control. Note that, in the figure, the portions duplicating those of FIG. 9 are denoted by the same symbols and the explanation thereof is appropriately omitted.

In FIG. 12, when the assist torque control is executed, the ECU 100 calculates a dumping control term CAdmp of the assist torque TA making use of calculators 110, 111, and 112 as well as control maps MP3, MP4, MP5, and MP6.

The calculated dumping control term CAdmp is a component of the assist torque TA, is added together with a basic assist torque TAbase and other control terms, for example, an inertia control term, a friction torque control term or a shaft force correction term, and the like, and is finally output from an EPS actuator 300 as the assist torque TA.

The dumping control term CAdmp is shown as Expression (33) by the operations of calculators 110, 111 and 112 as multipliers.

CAdmp=CAdmpbase×GNv×GNρ′×GNΔρ (33)

In Expression (33), CAdmpbase is a basic dumping control term and is set by the control map MP4. Further, GNv is a vehicle speed gain to execute control substantial in the medium and high vehicle speed region likewise the first embodiment and is set by the control map MP3 described above.

In contrast, gains GNρ′ and GNΔρ are a previously read curvature gain and a curvature deviation gain, respectively and are set by the control maps MP5 and MP6, respectively.

The control map MP4 is a map for causing a steering angular speed MA′ to correspond to a basic dumping control term CAdmpbase.

As apparent from the control map MP4, the basic dumping control term CAdmpbase changes in response to the steering angular speed MA′ and is zero at the time of soft steering in which the steering angular speed MA′ becomes less than a reference value. This is because there is a less fear that steering operation damages stability of a vehicle at the time of soft steering, and it is meant that dumping control is not originally required. When the steering angular speed MA′ becomes equal to or more than the reference value, the basic dumping control term CAdmpbase linearly increases with respect to the steering angular speed MA′.

The control map MP5 is a map for causing the previously read curvature ρ′(t) to correspond to a curvature gain GNρ′, and although a property of the map is the same as the control map MP3 according to the first embodiment, a mode for setting the curvature gain GNρ′ is different from the first embodiment.

That is, according to the control map MP5, the curvature gain GNρ′ linearly increases with respect to the previously read curvature ρ′(t) in a region less than the reference value and is kept constant in a maximum value in a region equal to or more than the reference value. Further, the curvature gain GNρ′ is larger than 1 except a minimum region in which the previously read curvature ρ′ employs a minimum value. That is, the basic dumping control term CAdmpbase is substantially amplified in response to the previously read curvature ρ′(t), and, in particular, in the region in which the previously read curvature ρ′(t) becomes less than the reference value, an increase of the previously read curvature ρ′(t) more increases the basic dumping control term CAdmpbase.

The control map MP6 is a map for causing a second curvature deviation Δρ(t) to correspond to a curvature deviation gain GNΔρ. Note that the second curvature deviation Δρ(t) is a difference between the curvature ρ(t) at a present position and a latest value ρ′(t) of the previously read curvature and shown by Expression (34). The second curvature deviation Δρ(t) is used as an index for previously anticipating a magnitude of a steering input which will be generated in future.

Δρ(t)=ρ′(t)−ρ(t) (34)

According to the control map MP6, the curvature deviation gain ΔGNρ linearly increases with respect to the second curvature deviation Δρ(t) in the region less than the reference value and is kept constant in a maximum value in the region equal to or more than the reference value. Further, the curvature deviation gain GNΔρ is larger than 1 except a minimum region in which the second curvature deviation Δρ employs a minimum value. That is, the basic dumping control term CAdmpbase is substantially amplified in response to the second curvature deviation Δρ(t), and, in particular, in the region in which the second curvature deviation Δρ(t) becomes less than the reference value, an increase of the second curvature deviation Δρ(t) more increases the basic dumping control term CAdmpbase.

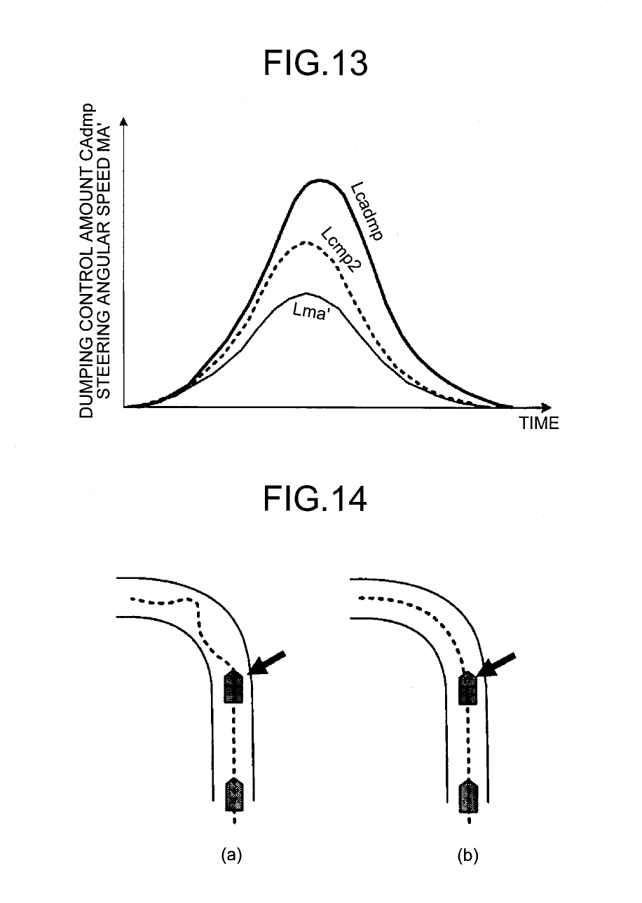

As a result that characteristics are applied by the respective control maps, a dumping control amount CAdmp of the assist torque TA shows a time transition as exemplified in, for example, FIG. 13. FIG. 13 is a view exemplifying a transition per hour of the dumping control amount CAdmp in an executing process of the assist torque control.

In FIG. 13, Lma′ illustrated by a thin solid line is a transition per hour of the steering angular speed MA′. When the assist torque control according to the embodiment is not executed to the time transition of the steering angular speed MA′, the dumping control amount CAdmp shows change characteristics as illustrated by a broken line Lcmp2 illustrated in the figure. In contrast, when the assist torque control according to the embodiment is executed, the dumping control amount CAdmp changes as illustrated by a solid line Lcadmp illustrated in the figure. That is, when the assist torque control according to the embodiment is executed, the dumping control amount CAdmp generally increases.

As described above, according to the assist torque control, mainly in the medium and high vehicle speed region, basically, a larger previously read curvature ρ′(t) and further a larger second curvature deviation Δρ(t) more increases the dumping control term CAdmp of the assist torque TA. The dumping control term is a control term for prescribing viscosity of the steering wheel and means that a lager dumping control term more increases the viscosity when the steering wheel is in operation. When the viscosity increases when the steering wheel is in operation, since a resistance at the time the driver applies the steering input increases, a sensitivity of a steering angle to the steering input becomes dull. Further, the driver feels as if the steering wheel becomes heavy and that a so-called “response” increases.

That is, according to the assist torque control, when it is generally expected that a large steering input is applied from the driver in future such as when a curvature of a center of gravity, that is, the previously read curvature ρ′ at a provisional travel position to which the vehicle 1 will reach in future is large and when a difference between the curvature ρ(t) at the present position and the previously read curvature ρ′(t) is large, and the like, a sensitivity of the steering angle to the steering input can be previously reduced. Further, the steering wheel can be made heavy. Accordingly, even if an unexpected disturbance occurs and the steering input of the driver is disturbed at the time the vehicle 1 actually approaches a curved road or approaches a straight road from a curved road, and the like, the disturbance of the steering input does not stagger the vehicle 1 and a stable travel state can be maintained. Otherwise, at the stage that the driver predicts a future curvature and potentially expects a response to the steering wheel, a feeling of response of the steering wheel can be amplified.

An effect of the assist torque control will be explained referring to FIG. 14. FIG. 14 is a schematic vehicle travel state view exemplifying the effect of the assist torque control.

In FIG. 14, FIG. 14(a) is a view exemplifying a vehicle travel state when the assist torque control is not executed. In the case, when a disturbance corresponding to an arrow illustrated in the figure occurs at the stage that the vehicle 1 approaches a curved road, the steering input of the driver is disturbed by the disturbance and the disturbed steering input interferes with a steering operation corresponding to the curved road, thereby a locus of the curved road is likely staggered as illustrated by a broken line illustrated in the figure.

In contrast, when the assist torque control is executed, since the dumping control term CAdmp of the assist torque TA is previously increased based on the previously read curvature ρ′(t) before the vehicle 1 approaches the curved road, a disturbance of vehicle behavior caused by a disturbance input illustrated by the arrow does not occur as exemplified in FIG. 14(b). That is, the vehicle behavior becomes robust to the disturbance by the assist torque control.

Further, the stagger of the vehicle behavior exemplified in FIG. 14(a) may occur even if a disturbance is not input. For example, the driver potentially expects a response of the steering wheel at the stage that he or she predicts a future curvature. However, when only control based on an actual curvature is executed, since it is only after the vehicle has approached the curved road that the dumping control term begins to change the response of the steering wheel, the driver approaches the curved road while feeling that the steering wheel is light. However, when an effect of the dumping control begins to be exerted just after the driver has felt that the steering wheel is light, the driver feels that the steering wheel becomes heavy this time. That is, the driver has a large uncomfortable feeling to the steering feeling. As a result, redundant steering operation, that is, a so-called correct steering is likely executed. The redundant steering operation eventually disturbs the vehicle behavior as exemplified in FIG. 14(a). According to the embodiment, since a steering feeling in conformity with a feeling of the driver is provided, it is possible to more stabilize the vehicle behavior.

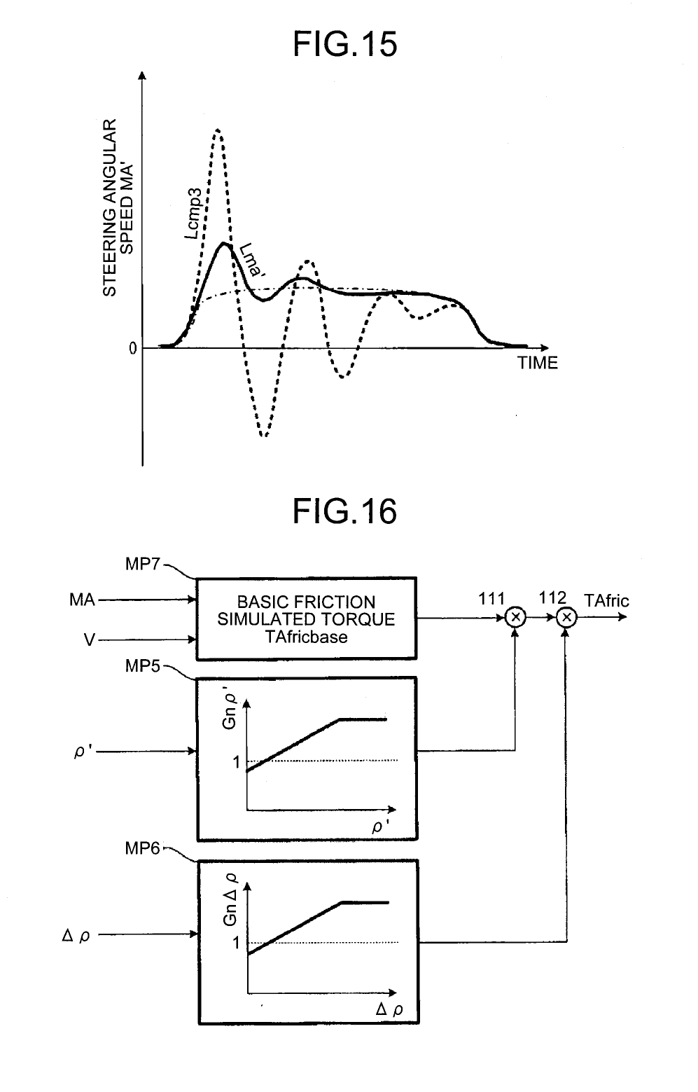

Next, the effect of the assist torque control will be explained from a different point of view referring to FIG. 15. FIG. 15 is a view exemplifying a transition per hour of the steering angular speed MA′ in the executing process of the assist torque control.

In FIG. 15, a time transition of the steering angular speed MA′ when the assist torque control according to the embodiment is executed is illustrated as Lma′ (solid line) illustrated in the figure. In contrast, a time transition of the steering angular speed MA′ when the assist torque control is not executed is illustrated as Lcmp3 (broken line) illustrated in the figure. Note that a dot-dash line exemplifies characteristics when no disturbance occurs.

As exemplified in FIG. 15, when the assist torque control is applied, since the dumping control term is controlled based on the previously read curvature ρ′(t) (is substantially increased in most cases) and thus a change of the steering angle MA when certain steering torque is applied becomes small, a width of change of the steering angular speed MA′ is largely suppressed as compared with a case in which the assist torque control is not executed. It will be apparent that the vehicle behavior can be more stabilized when the width of change of the steering angular speed MA′ is small or a change of speed low.

### Third Embodiment

In the second embodiment, as a control mode of the assist torque, although the steering feeling in conformity with the feeling of the driver is provided by increasing the dumping control term CAdmp as a component of the assist torque TA or the robust property of the vehicle behavior to a disturbance is improved, in a third embodiment, a friction simulated torque TAfric as a part of the assist torque TA is increased in place of the dumping control term. The friction simulated torque TAfric is torque that imitates a physical friction force generated when a steering wheel 11 is operated. At the time of actual control, for example, step S303 in a steering wheel controlling process of FIG. 11 is replaced with a friction simulated torque control.

The friction simulated torque control will be explained in detail referring to FIG. 16. FIG. 16 is a control block diagram of the friction simulated torque control. Note that, in the figure, the portions duplicating those of FIG. 12 are denoted by the same symbols and the explanation thereof is appropriately omitted.

In FIG. 16, when the friction simulated torque control is executed, an ECU 100 calculates the friction simulated torque TAfric making use of calculators 111 and 112 as well as control maps MP5, MP6, and MP7. The ECU 100 is configured to determine a final target value TAtag of the assist torque TA by adding the calculated friction simulated torque TAfric to a target value of other component of the assist torque TA as well as to control an EPS actuator so that the target value TAtag can be acquired.

The friction simulated torque TAfric is shown as Expression (35) by the operations of the calculators 111 and 112 as multipliers.

TAfric=TAfricbase×GNρ′×GNΔρ (35)

In Expression (35), TAfricbase shows basic friction simulated torque and is set by the control map MP7. The control map MP7 is a control map that uses a steering angle MA and a vehicle speed V as parameters and causes the parameters to correspond to the basic friction simulated torque. Basic friction simulated torque TAfricbase is basically set such that it is more increased as the steering angle MA is larger and further the vehicle speed V is higher. Note that, as described above, the basic friction simulated torque does not react to a steering angular speed MA′ but reacts to a steering angle MA different from the dumping control amount described above. Accordingly, even when the steering wheel is not operated or is operated soft, a reaction force that becomes a so-called response to the steering wheel can be applied.

In contrast, gains GNρ′ and GNΔρ are a previously read curvature gain and a curvature deviation gain, respectively and are similar to the control maps MP5 and MP6 exemplified FIG. 12, respectively. Accordingly, the basic friction simulated torque TAfricbase is amplified in most cases likewise the basic dumping control term in the second embodiment.

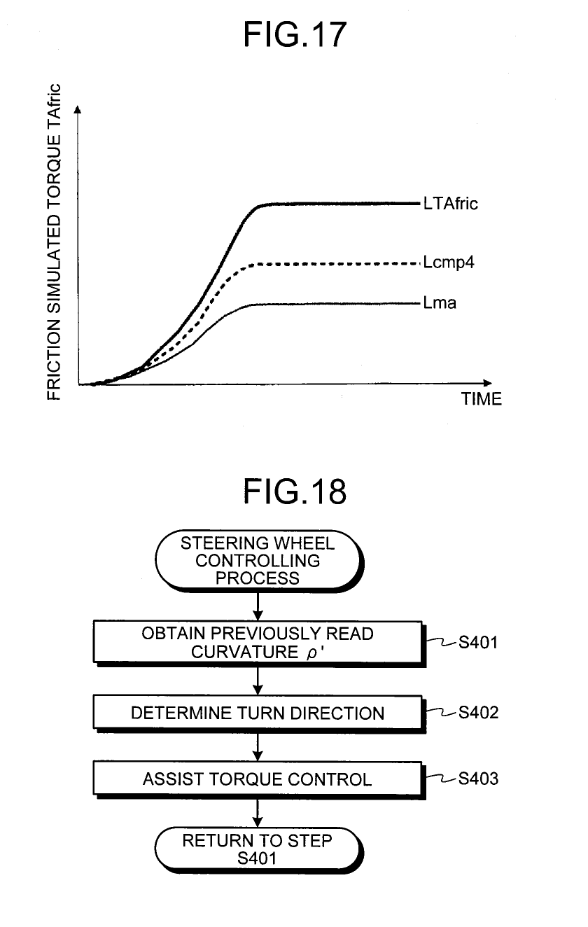

An effect of the friction simulated torque control will be explained here referring to FIG. 17. FIG. 17 is a view exemplifying a transition per hour of the friction simulated torque TAfric in an executing process of the friction simulated torque control.

In FIG. 17, Lcmp4 (broken line) exemplifies a time transition of the friction simulated torque TAfric when the friction simulated torque control is not executed as an comparative example, and LTAfric (solid line) exemplifies a time transition of the friction simulated torque TAfric when the friction simulated torque control is executed. Note that Lma (thin solid line) exemplifies a time transition of the steering angle MA.

As illustrated in the figure, when the friction simulated torque control is executed, the friction simulated torque TAfric is more increased than the comparative example. Further, in particular, as illustrated in the figure, the friction simulated torque TAfric employs a predetermined value except zero according to the steering angle MA even in a state in which the steering angle MA is stable (that is, the steering angular speed MA′=0). Although the dumping control term according to the second embodiment is a torque component which is not generated unless steering operation is executed (that is, which is not generated at steering angular speed MA′=0), since a suitable friction force is kept even when steering is kept stable as described above, the friction simulated torque control according to the embodiment has a good astringent property of vibration of the steering wheel at the time of stable steering, so that it is possible to more stabilize the steering operation.

Further, since the friction simulated torque TAfric is qualitatively torque having action for making the steering operation heavier when it is increased, a robust property when a disturbance is input can be improved likewise the second embodiment by increasing the friction simulated torque TAfric based on a previously read curvature ρ′(t) before the vehicle 1 approaches a curved road from a straight road or before the vehicle 1 approaches a straight road from a curved road. Further, a steering feeling in conformity with the feeling of the driver can be provided.

Note that although the friction simulated torque TAfric that is a part of the assist torque TA is exemplified here, a friction force according to the steering angle MA can be also applied by controlling a friction control term that is a component of the assist torque TA likewise the dumping control term described above.

### Fourth Embodiment

Next, a fourth embodiment of the present invention will be explained referring to FIG. 18 to FIG. 27.

In the first to third embodiments, although the assist torque TA is controlled based on the previously read curvature ρ′(t) (estimated turning curvature) in the steering wheel controlling process executed by the ECU 100 (the control means), in a fourth embodiment, the assist torque TA is controlled based on a time change amount (differential value) of the previously read curvature ρ′(t). Further, the embodiment is different from the embodiments described above in that, in a steering wheel controlling process, a basic assist torque TAbase for setting a reference to the assist torque TA is determined based on a steering torque MT.

First, the steering wheel controlling process according to the fourth embodiment will be explained referring to FIG. 18. FIG. 18 is a flowchart of the steering wheel controlling process according to the fourth embodiment of the present invention.

As illustrated in FIG. 18, an ECU 100 acquires a previously read curvature ρ′ (step S401), determines a turn direction of a vehicle 1 based on the previously read curvature ρ′ having been acquired (step S402), and calculates a previously read curvature ρs with symbol in which the turn direction is illustrated by a symbol. The assist torque control is executed based on the previously read curvature ρs with symbol (step S403). When the assist torque control has been executed, a process is returned to step S401 and a series of processes is repeated.

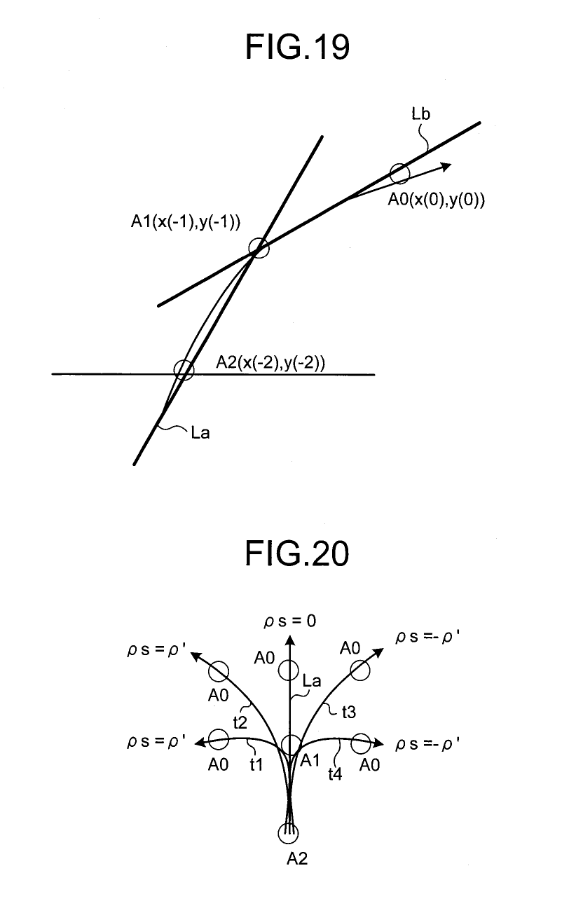

The turn direction determination at step S402 will be explained in detail here referring to FIGS. 19, 20. FIG. 19 is a conceptual view of the turn direction determination, and FIG. 20 is a view exemplifying an addition of symbol to the previously read curvature ρ′ according to a previously read locus in the turn direction determination.

In the first to third embodiments, although it is sufficient to use the absolute value paying attention to the change of magnitude of the previously read curvature ρ′ because the control is executed, in the embodiment, since the control is executed paying attention to the time change amount of the previously read curvature ρ′, it is necessary to determine whether the previously read curvature ρ′ is being turned left or right. Thus, in the embodiment, the previously read curvature ρ′ is expanded to the previously read curvature ρs with symbol.

Specifically, a turn direction of the vehicle 1 is determined using “at least three vehicle position information” used when the previously read curvature ρ′ is determined at step S106 of FIG. 4, and the previously read curvature ρs with symbol is calculated by applying a symbol in response to a turn direction to the previously read curvature ρ′. Likewise the explanation at step S106, cases of a previously read position A0 (x(0), y(0)), a once past previously read position A1 (x(−1), y(−1)), and a twice past previously read position A2 (x(−2), y(−2)) will be explained here as illustrated in FIG. 19.

As illustrated in FIG. 19, a straight line La connecting the once past previously read position A1 to the twice past previously read position A2 is shown by next Expression.

y=a1×x+b1 (36)

However,

a1=(y(−1)−y(−2))/(x(−1)−x(−2)) (37)

b1=y(−1)−a1×x(−1) (38)

Further, as illustrated in FIG. 19, a straight line Lb connecting the previously read position A0 to the once past previously read position A1 is shown by next Expression.

Y=a2×x+b2 (39)

However,

a2=(y(0)−y(−1))/(x(0)−x(−1)) (40)

b2=y(0)−a2×x(0) (41)

As to the three points A0, A1, A2 defined as described above, in the embodiment, when a time transition is illustrated upward as illustrated in FIGS. 19, 20, that is, when the twice past previously read position A2, the once past previously read position A1, and the previously read position A0 are plotted in this order from downward to upward, it is determined a left turn when the previously read position A0 is located on a left side of the straight line La connecting the once past previously read position A1 to the twice past previously read position A2, and it is determined a right turn when the previously read position A0 is located on a right side of the straight line La. The previously read curvature ρs with symbol is defined so that a left turn is illustrated by negative and a right turn is illustrated by positive.

When, for example, plural previously read loci are examined as illustrated in FIG. 20, in the case of previously read loci t1, t2 in which the previously read positions A0 are located on a left side of the straight line La connecting the once past previously read position A1 to the twice past previously read position A2, it is determined that the left turn is executed, a positive symbol is applied to the previously read curvature ρ′, and the previously read curvature ρs with symbol is defined. That is, ρs=ρ′ is established.

Further, in the case of previously read loci t3, t4 in which the previously read positions A0 are located on a right side of the straight line La connecting the once past previously read position A1 to the twice past previously read position A2, it is determined that the right turn is executed, a negative symbol is applied to the previously read curvature ρ′, and the previously read curvature ρs with symbol is defined. That is, ρs=−ρ′ is established.

When the previously read position A0 is located on the straight line La, since the vehicle 1 travels straight and the previously read curvature ρ′ is 0, the previously read curvature ρs with symbol is also defined as 0. That is, ρs=0 is established.

When attention is paid to tilts a1, a2 of the respective straight lines La, Lb, in the case of the left turn as in the previously read loci t1, t2 of FIG. 20, the tilt a1 of the straight line La connecting the once past previously read position A1 to the twice past previously read position A2 becomes smaller than the tilt a2 of the straight line Lb connecting the previously read position A0 to the once past previously read position A1.

Further, in the case of the right turn as in the previously read loci t3, t4 of FIG. 20, the tilt a1 of the straight line La becomes larger than the tilt a2 of the straight line Lb, and when the previously read position A0 is located on the straight line La, the tilt a1 of the straight line La becomes the same as the tilt a2 of the straight line Lb.

Accordingly, the previously read curvature ρs with symbol can be defined by the following condition paying attention to the tilts a1, a2 of the respective straight lines La, Lb so that they become positive in the left turn and becomes negative in the right turn.
when a1>a2, ρs=−ρ′ because of right turn
when a1<a2, ρs=ρ′ because of left turn
when a1=a2, ρs=0 because of straight travel

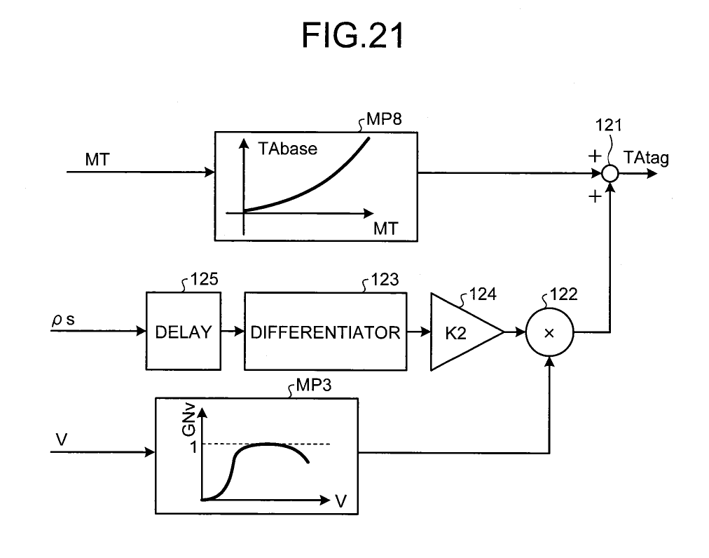

Next, the assist torque control at step S403 will be explained in detail referring to FIG. 21. FIG. 21 is a control block diagram of the assist torque control. Note that, in FIG. 21, the portions duplicating those of FIG. 9 and FIG. 12 are denoted by the same symbols and the explanation thereof is appropriately omitted.

In FIG. 21, when the assist torque control is executed, the ECU 100 calculates a target value TAtag of the assist torque TA making use of an adder 121, a multiplier 122, a differentiator 123, a gain multiplier 124, a delay (delay device) 125, and control maps MP8, MP3. The ECU 100 controls an EPS actuator 300 in response to the calculated target value TAtag and generates a desired assist torque TA.

More specifically, the target value TAtag of the assist torque TA is shown as Expression (42) by operation of the adder 121.

TAtag=TAbase+dpV2 (42)

In Expression (42), TAbase is basic assist torque for setting a reference to the assist torque TA and is set by the control map MP8.

The control map MP8 is a map for causing the steering torque MT to correspond to the basic assist torque TAbase. As apparent from the control map MP8 exemplified in FIG. 21, the basic assist torque TAbase changes in response to the steering torque MT and is set so that it basically becomes larger as the steering torque MT is larger.

Further, in Expression (42), dρV2 is a correction amount of the assist torque TA derived based on a differential value of the previously read curvature ρs with symbol. When target value of the assist torque control is shown as the basic assist torque TAbase, an initial response delay is large with respect to target assist characteristics. Thus, to improve responsiveness of the assist torque control, the assist torque correction amount dρV2 is added as in Expression (42). A method of deriving the assist torque correction amount dρV2 will be explained below in detail.

The assist torque correction amount dρV2 is shown as Expression (43) by the operation of the multiplier 122.

dρV2=GNv×dρ2·K2 (43)

where, dρ2 is a differential value of the previously read curvature ρs with symbol and calculated by the differentiator 123 as described later. Further, K2 is a predetermined gain and multiplied to dρ2 by the gain multiplier 124.

Note that GNv of Expression (43) is a vehicle speed gain set by the control map MP3 based on a vehicle speed V likewise the first and second embodiments and multiplied to an output dp2·K2 from the gain multiplier 124 by the multiplier 122. Since the previously read curvature ρ′ can be effectively extracted mainly at medium and high speeds, the vehicle speed gain GNv is set so that it becomes large at the medium and high speeds as in the control map MP3 exemplified in FIG. 21. A correspondence between the vehicle speed V and the vehicle speed gain GNv illustrated in the control map MP3 can be adapted, for example, by way of experiment.

A gain K2 is set with such an amount that a response delay that may be generated in the assist torque control using only the basic assist torque TAbase can be compensated by dp2·K2 that is acquired by multiplying a differential value dρ2 of the previously read curvature ρs with symbol by the gain K2. The gain K2 can be determined by design or experiment.

A differential value dρ2 of the previously read curvature ρs with symbol is shown as Expression (44) by the differentiator 123.

dρ2=(ρd2(t)−ρd2(t−sampling_time))/sampling_time (44)

where, ρd2 is a “previously read curvature after delay” subjected to a delay arithmetic operation for inputting a delay td to the previously read curvature ρs with symbol and calculated by the delay (delay device) 125 as described later. Further, sampling_time is a sampling interval. That is, the differential value dρ2 of the previously read curvature ρs with symbol is a time change amount of a previously read curvature ρs that is calculated by dividing a difference between a present time value ρd2 (t) and a previous time value ρd2 (t−sampling_time) of the previously read curvature after delay by the sampling interval sampling_time.

The previously read curvature ρd2 after delay is calculated by executing a delay process for inputting a delay td2 to the previously read curvature ρs with symbol by the delay (delay device) 125 and can be shown as, for example, Expression (45).

ρd2(t)=ρs(t−td2) (45)

where, td2 is a parameter for adjusting a magnitude of the delay, set within a range of td=0 to a2/V (a2 is a constant) and is variable depending on the vehicle speed V.

That is, as to the previously read curvature ρs with symbol that is input information of the assist torque control at step S403, first, a delay process of Expression (45) is executed by the delay 125, next, the differential value dρ2 is calculated from Expression (44) by the differentiator 123, the gain K2 is multiplied by the gain multiplier 124 as shown in Expression (43), and the vehicle speed gain GNv in response to the vehicle speed V is multiplied by the multiplier 122, with a result that the previously read curvature ρs with symbol is output as the assist torque correction amount dρV2.

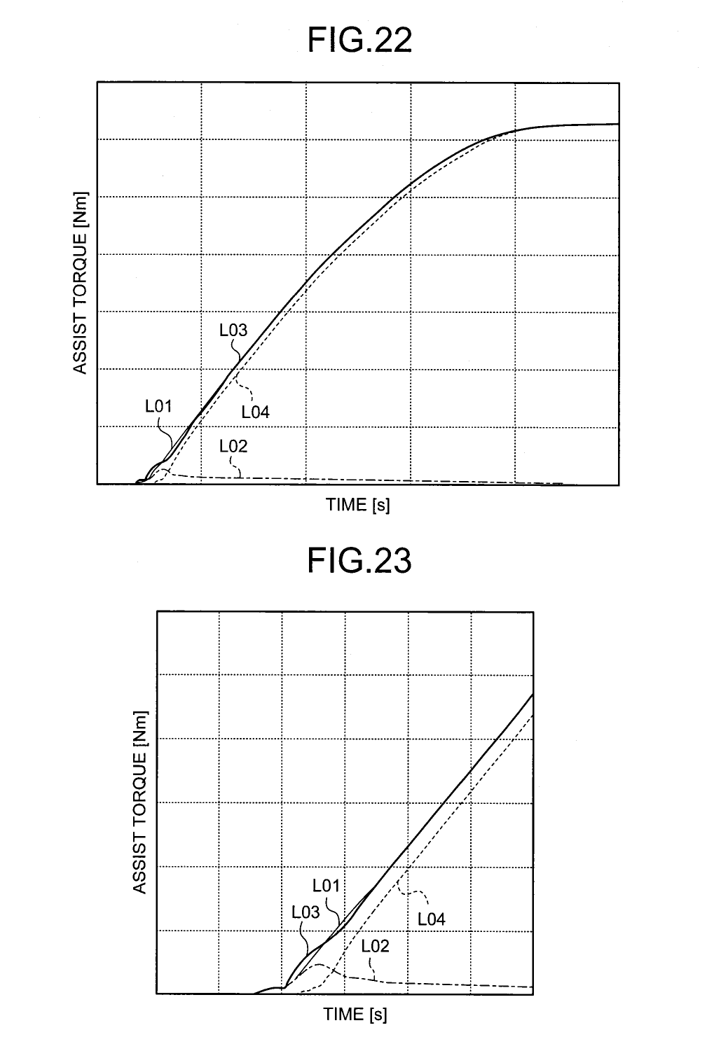

An effect of the assist torque control of the embodiment will be explained referring to FIGS. 22, 23. FIG. 22 is a view exemplifying a time transition of the assist torque in an executing process of the assist torque control, and FIG. 23 is an enlarged view illustrating an initial portion of the assist torque control in the time transition of the assist torque illustrated in FIG. 22.

In FIGS. 22, 23, graphs L01 illustrated by a thin solid line illustrate target assist characteristics illustrating a time transition of a target value of the assist torque control determined in response to the steering torque MT. The target assist characteristics L01 are specifically the basic assist torque TAbase derived using the control map MP8 based on the steering torque MT in the control block diagram of the assist torque control illustrated in FIG. 21. In an example illustrated in FIGS. 22, 23, the target assist characteristics L01 are continuously increased from 0 to a predetermined value.

In FIGS. 22, 23, graphs L02 illustrated by a single-dashed line show a time transition the assist torque correction amount dρV2 calculated based on the differential value of the previously read curvature ρ′ (previously read curvature ρs with symbol) in the embodiment. Further, a graph L03 illustrated by a thick solid line illustrates a time transition of the assist torque TA output from the EPS actuator 300 when a process for adding the assist torque correction amount dρV2 of the embodiment to an assist torque target value TAtag is applied (hereinafter, called a previously read curvature differentiation correction). Further, graphs L04 illustrated by a broken line illustrate a time transition of the assist torque TA output from the EPS actuator 300 as an comparative example when the previously read curvature differentiation correction of the embodiment is not executed (when only the basic assist torque TAbase is used as the assist torque target value TAtag).

As illustrated in graphs L04 of FIGS. 22, 23, in the comparative example in which the assist torque target value TAtag is made only to the basic assist torque TAbase derived from the control map MP8 of FIG. 21, the time transition of the assist torque TA output from the EPS actuator 300 has a large response delay with respect to the target assist characteristics L01 when it rises and a steady deviation remains although the time transition follows the target assist characteristics L01. As described above, when only the basic assist torque TAbase is used as the assist torque target value TAtag, since a sufficient assist torque TA in response to the steering torque MT cannot be realized due to, in particular, the response delay of the assist torque TA at the beginning of steering, there may be a possibility that steering characteristics in conformity with an intention of the driver cannot be acquired.

In contrast, in the embodiment, to preferably provide the assist torque TA for assisting the steering torque MT of the driver, the assist torque TA is controlled based on the differential value of the previously read curvature ρ′. More specifically, in the embodiment, the assist torque correction amount dρV2 illustrated in graphs L02 of FIGS. 22, 23 is calculated based on the differential value of the previously read curvature ρ′ and added to the assist torque target value TAtag. In particular, as illustrated in the graph L02, at the beginning of steering in which the target assist characteristics L01 largely change and the response delay is generated in the comparative example (graph L04), the assist torque correction amount dρV2 is set to a large value, so that the response delay of the assist torque TA can be compensated.

With the configuration, in the embodiment, since it becomes possible to reflect a change amount of the previously read curvature ρ′ which is road information at a provisional travel position ahead of a present position to steering control of the vehicle 1 at the present point of time and to control the assist torque TA in a feed forward fashion, it becomes possible to cause the assist torque TA to approach the target assist characteristics L01 from the beginning of steering in comparison with the comparative example (graph L04) as illustrated in the graphs L03 of FIGS. 22, 23. Accordingly, since the steering torque is not increased by the response delay of the assist torque at the beginning of steering, steering characteristics in conformity with the intention of the driver can be acquired, so that the assist torque control in conformity with the feeling of the driver can be executed.

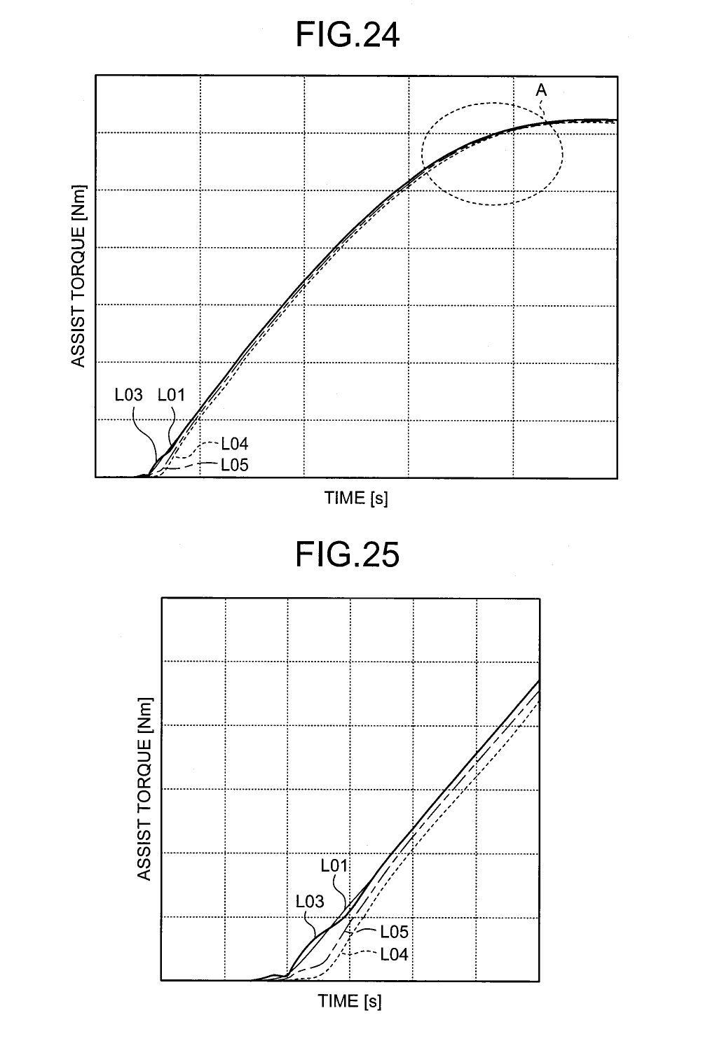

Next, an effect of the embodiment will be further explained by comparing the previously read curvature differentiation correction of the embodiment with a conventional compensation method. First, a comparison with a known torque differentiation compensation will be explained referring to FIGS. 24, 25. FIG. 24 is a view exemplifying the time transition of the assist torque using torque differentiation compensation as a comparative example, and FIG. 25 is an enlarged view illustrating an initial portion of the assist torque control in the time transition of the assist torque illustrated in FIG. 24.

The torque differentiation compensation is to improve the responsiveness of the assist torque control by adding a torque differentiation compensation amount, which is acquired by multiplying a gain to a differentiation correction value in response to a differential value of the steering torque MT, to main control for setting the assist torque target value TAtag in response to the steering torque MT.

In FIGS. 24, 25, a graph L05 illustrated by a single-dashed line shows the time transition of the assist torque TA output from the EPS actuator 300 when the torque differentiation compensation is applied to the assist torque control. Note that graphs L01, L03, L04 are the same as those in FIGS. 22, 23.

In the torque differentiation compensation, although the responsiveness of the assist torque control can be more improved by increasing the torque differentiation compensation amount by increasing the gain described above, since an excessive increase of the gain causes the assist torque TA to overshoot when the target assist characteristics L01 change from a monotonous increase to a constant value (region A illustrated in FIG. 24), there is a limit in the increase of the gain value to avoid the occurrence of the overshoot, so that there is a limit in the improvement of the responsiveness of the assist torque control. Accordingly, as illustrated in the graph L05 of FIG. 25, when the torque differentiation compensation is applied to the assist torque control, although the responsiveness of the assist torque can be more improved than the case that only the basic assist torque TAbase is used as the assist torque target value TAtag (graph L04), a response delay at the time of rising still remains and a deviation also remains.

In contrast, in the previously read curvature differentiation correction of the embodiment, as illustrated in graphs L03 of FIGS. 24, 25, it becomes possible to cause the assist torque TA to more approach the target assist characteristics L01 from the beginning of steering in comparison with the torque differentiation compensation (graph L05).

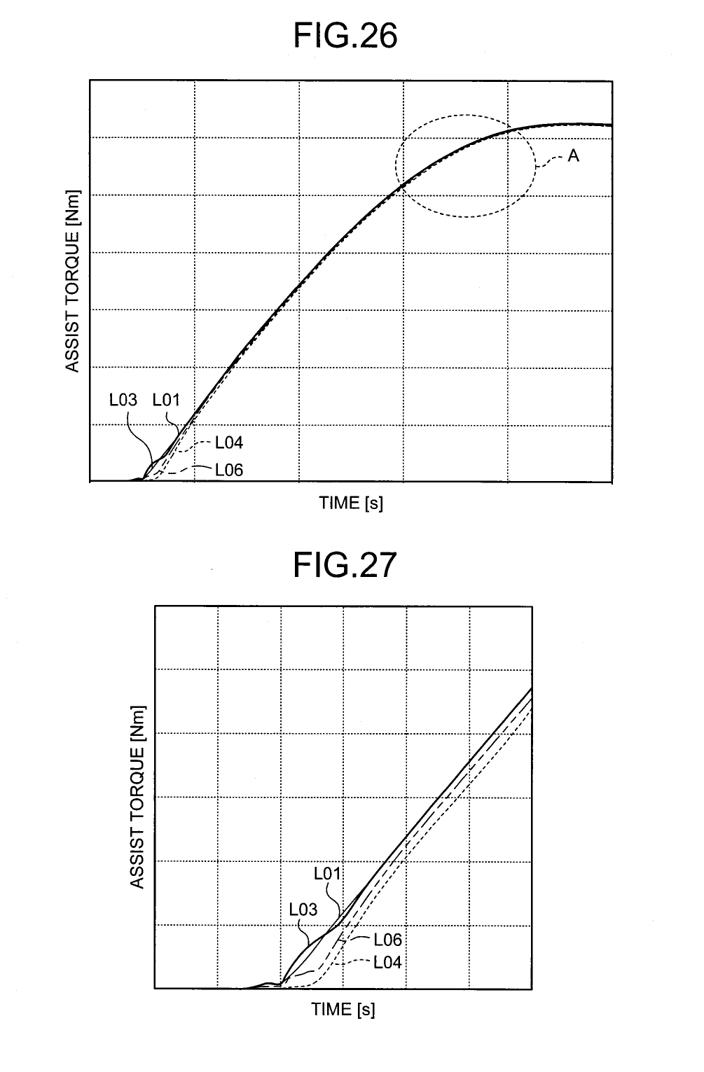

Next, a comparison with known δ differentiation compensation will be explained referring to FIGS. 26, 27. FIG. 26 is a view exemplifying the time transition of the assist torque using the δ differentiation compensation as a comparative example, and FIG. 27 is an enlarged view illustrating an initial portion of the assist torque control in the time transition of the assist torque illustrated in FIG. 26.

In FIGS. 26, 27, graphs L06 illustrated by a single-dashed line illustrate the time transition of the assist torque TA output from the EPS actuator 300 when the δ differentiation compensation is applied to the assist torque control. Note that the graphs L01, L03, L04 are the same as those of FIGS. 24, 25.

In the δ differentiation compensation, although an increase of a δ differentiation compensation amount can more improve the responsiveness of the assist torque control, since an excessive increase of the δ differentiation compensation amount causes the assist torque TA to overshoot when the target assist characteristics L01 change from a monotonous increase to a constant value (region A illustrated in FIG. 26), there is a limit in the increase of the δ differentiation compensation amount to avoid the occurrence of the overshoot, so that there is a limit in the improvement of the responsiveness of the assist torque control. Accordingly, as illustrated in the graphs L06 of FIG. 27, when the δ differentiation compensation is applied to the assist torque control, although the responsiveness of the assist torque can be more improved than the case that only the basic assist torque TAbase is used as the assist torque target value TAtag (graph L04), a response delay at the time of rising still remains and a deviation also remains.

In contrast, in the previously read curvature differentiation correction of the embodiment, as illustrated in graphs L03 of FIGS. 26, 27, it becomes possible to cause the assist torque TA to more approach the target assist characteristics L01 from the beginning of steering in comparison with the 8 differentiation compensation (graph L06).

As described above, the previously read curvature differentiation correction of the embodiment (graph L03) can preferably cause the assist torque TA to approach the target assist characteristics L01 from the beginning of steering in comparison with the conventional compensation methods such as the torque differentiation compensation (graph L05), the δ differentiation compensation (graph L06), and the like. Accordingly, the assist torque control in more conformity with the feeling of the driver can be executed.

### Fifth Embodiment

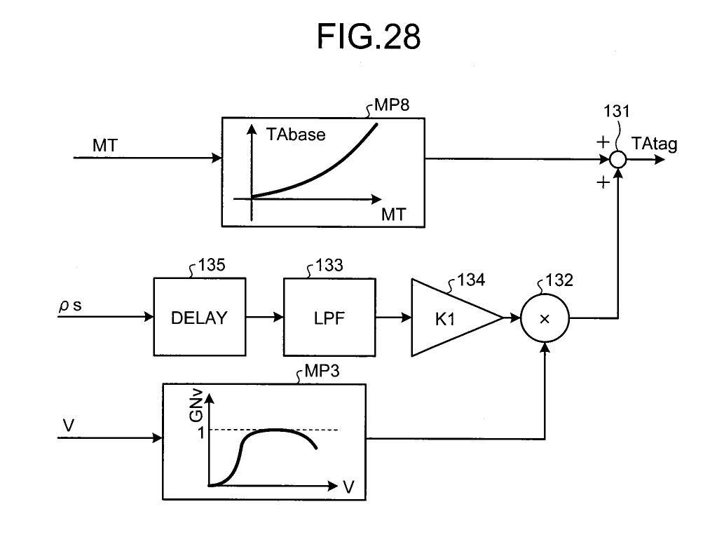

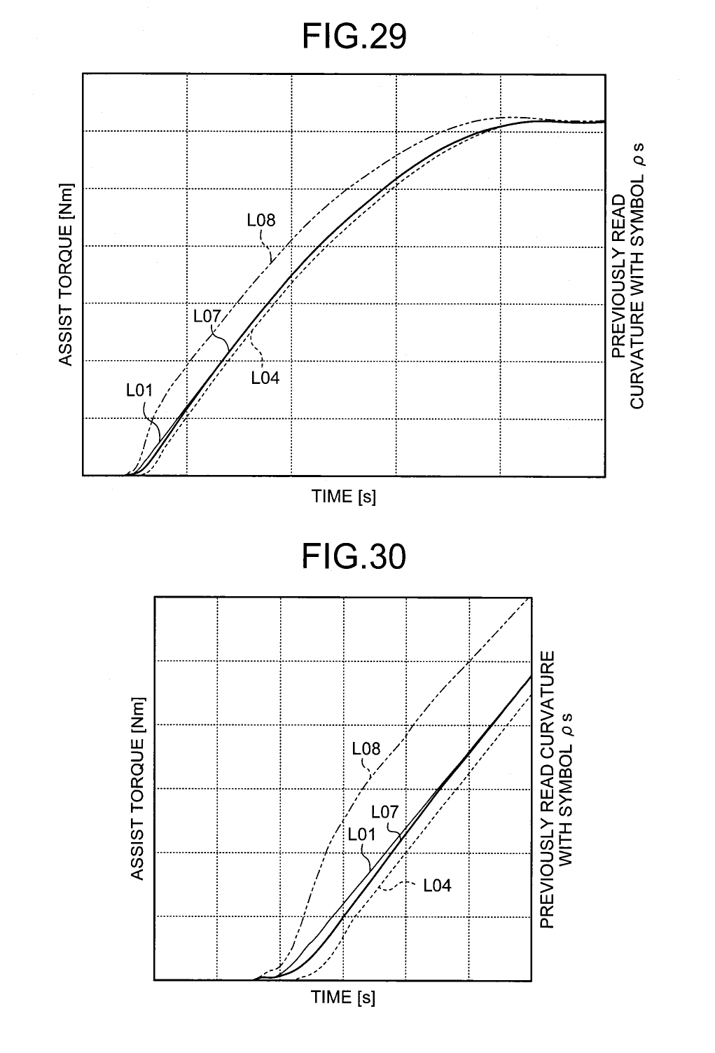

Next, a fifth embodiment of the present invention will be explained referring to FIG. 28 to FIG. 34.

In the fourth embodiment, although the correction amount of the assist torque control is controlled based on the time change amount (differential value) of the previously read curvature ρ′(t), the fifth embodiment is different from the fourth embodiment in that the correction amount of the assist torque control is calculated based on the previously read curvature ρ′(t). That is, in the embodiment, the contents of the assist torque control at step S403 in the steering wheel controlling process of the fourth embodiment explained referring to the flowchart of FIG. 18 are different.

The assist torque control at step S403 of the flowchart of FIG. 18 that is a point different from the fourth embodiment will be explained in detail referring to FIG. 28. FIG. 28 is a control block diagram of the assist torque control of the embodiment.

In FIG. 28, when the assist torque control is executed, an ECU 100 calculates a target value TAtag of an assist torque TA making use of an adder 131, a multiplier 132, a low-pass filter (LPF) 133, a gain multiplier 134, a delay (delay device) 135, and control maps MP8, MP3. When the target value is calculated, an EPS actuator 300 is controlled in response to the target value. More specifically, the target value TAtag of the assist torque TA is shown as Expression (46) by the operation of the adder 131.

TAtag=TAbase+dρV1 (46)

In Expression (46), TAbase is basic assist torque for setting a reference to the assist torque and set by the control map MP8 likewise the fourth embodiment.

Further, in Expression (46), dρV1 is a correction amount of the assist torque derived based on a previously read curvature ρs with symbol. When a target value of the assist torque control is shown by a basic assist torque TAbase, an initial response delay is large with respect to target assist characteristics. Thus, to improve responsiveness of the assist torque control, a correction amount dρV1 based on the previously read curvature ρs with symbol is added as shown in Expression (46). A deriving method thereof will be explained below in detail.

First, the delay (delay device) 135 executes a delay arithmetic operation for inputting a delay td1 to the previously read curvature ρs with symbol, thereby a “previously read curvature after delay” ρd1 is calculated. The previously read curvature ρd1 after the delay can be shown as, for example, Expression (47).

ρd1(t)=ρs(t−td1) (47)

Here, td1 is a parameter for adjusting a magnitude of the delay, is set within a range of td1=0 to a1/V (a1 is constant), and is variable depending on a vehicle speed V. Note that characteristics of the delay amount td1 depending on the vehicle speed V can be made the same as those of td2 of the fourth embodiment.

Next, the previously read curvature ρd1 after the delay is subjected to a filter process by the low-pass filter (LPF) 133 and calculated as “a previously read curvature with symbol dρ1 after the filter process” whose phase has been adjusted.

Next, a predetermined gain K1 is multiplied to the previously read curvature with symbol dρ1 after the filter process by the gain multiplier 134. The gain K1 is set to an amount capable of compensating a response delay that may be generated in the assist torque control that uses only the basic assist torque TAbase by dρ1·K1 acquired by multiplying a K1 gain to the previously read curvature with symbol dρ1 which has been subjected to the filter process. The gain K1 can be determined by design or experiment.

Next, a vehicle speed gain GNv is further multiplied to dρ1·K1 calculated by the gain multiplier 134 by operation of the multiplier 132 and an assist torque correction amount dρV1 is calculated. The assist torque correction amount dρV1 is shown as Expression (48).

dρV1=GNv×dρ1·K1 (48)

Note that the vehicle speed gain GNv of Expression (48) is set by the control map MP3 based on the vehicle speed V likewise the fourth embodiment.

An effect of the assist torque control of the embodiment will be explained referring to FIGS. 29, 30.

FIG. 29 is a view exemplifying a time transition of the assist torque in an executing process of the assist torque control, and FIG. 30 is an enlarged view illustrating an initial portion of the assist torque control in the time transition of the assist torque illustrated in FIG. 29.

In FIGS. 29, 30, graphs L07 illustrated by a thick solid line illustrate a time transition of the assist torque TA output from the EPS actuator 300 when a process for adding the assist torque correction amount dρV1 of the embodiment to the assist torque target value TAtag (hereinafter, called a previously read curvature correction) is applied. Further, graphs L08 illustrated by a double-dashed line illustrate a time transition of the previously read curvature ρs with symbol in conformity with a scale of the assist torque. Note that, likewise FIG. 22, graphs L01 illustrate target assist characteristics, and graphs L04 illustrate the time transition of the assist torque TA output from the EPS actuator 300 when the previously read curvature correction of the embodiment is not executed (when only the basic assist torque TAbase is used as the assist torque target value TAtag) as a comparative example.

As illustrated in the graphs L04 of FIGS. 29, 30, in the comparative example in which the assist torque target value TAtag is made only to the basic assist torque TAbase derived from the control map MP8 of FIG. 28, the time transition of the assist torque TA output from the EPS actuator 300 has a large response delay with respect to target assist characteristics L01 at the time of rising and although the time transition follows the target assist characteristics L01, a steady deviation remains. As described above, when only the basic assist torque TAbase is used as the assist torque target value TAtag, since a sufficient assist torque TA in response to the steering torque MT cannot be realized due to, in particular, the response delay of the assist torque TA at the beginning of steering, there may be a possibility that steering characteristics in conformity with an intention of the driver cannot be acquired.

In contrast, in the embodiment, to preferably supply the assist torque TA for assisting the steering torque MT of the driver, the assist torque TA is controlled based on the previously read curvature ρ′. Since the previously read curvature ρ′ is road information at a provisional travel position ahead of a present position, as illustrated in the graphs L08 of FIGS. 29, 30, the previously read curvature ρ′ has such characteristics that it makes a time transition similar to that of the target assist characteristics L01 as well as a timing of the time transition becomes faster than the target assist characteristics L01. Thus, the embodiment is configured to be able to realize an assist torque TA desired by the driver by calculating the assist torque correction amount dρV1 based on the previously read curvature ρ′ and adding it to the assist torque target value TAtag.

With the configuration, in the embodiment, since it becomes possible to reflect the previously read curvature ρ′ that is the road information at the provisional travel position ahead of the present position to steering control of the vehicle 1 at the present point of time and to control the assist torque TA in a feed forward fashion, so that it becomes possible to cause the assist torque TA to approach the target assist characteristics L01 from the beginning of steering in comparison with the comparative example (graph L04) as illustrated in the graphs L07 of FIGS. 29, 30. Accordingly, since the steering torque is not increased by the response delay of the assist torque at the beginning of steering, steering characteristics in conformity with the intention of the driver can be acquired, so that the assist torque control in conformity with the feeling of the driver can be executed.

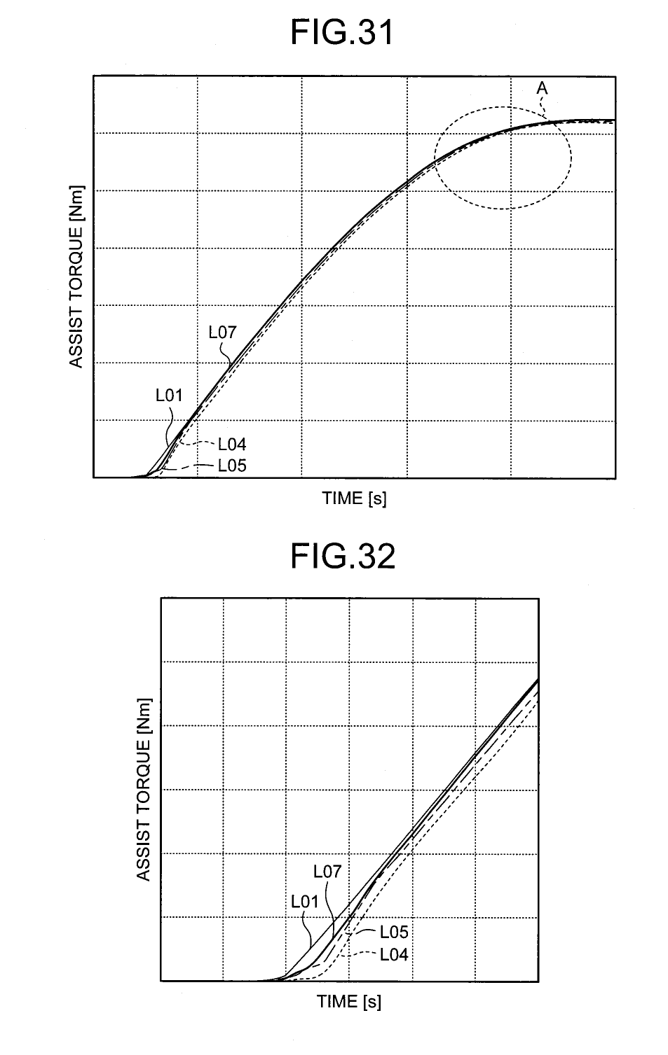

Next, the effect of the embodiment will be further explained by comparing the previously read curvature correction of the embodiment with conventional compensation methods. First, a comparison with known torque differentiation compensation will be explained referring to FIG. 31, 32. FIG. 31 is a view exemplifying a time transition of the assist torque using the torque differentiation compensation as a comparative example, and FIG. 32 is an enlarged view illustrating an initial portion of the assist torque control in the time transition of the assist torque illustrated in FIG. 31.

In FIGS. 31, 32, graphs L05 illustrated by a single-dashed line show the time transition of the assist torque TA output from the EPS actuator 300 when the torque differentiation compensation is applied to the assist torque control likewise FIGS. 24, 25. Note that the graphs L01, L04, L07 are the same as those of FIGS. 29, 30.

As illustrated in the graph L05 of FIG. 32, when the torque differentiation compensation is applied to the assist torque control, although the responsiveness of the assist torque can be more improved than the case that only the basic assist torque TAbase is used as the assist torque target value TAtag (graph L04) as explained referring to FIGS. 24, 25, a response delay at the time of rising still remains and a deviation also remains.

In contrast, in the previously read curvature correction of the embodiment, as illustrated in the graphs L07 of FIGS. 31, 32, it becomes possible to cause the assist torque TA to more approach the target assist characteristics L01 from the beginning of steering in comparison with the torque differentiation compensation (graphs L05).

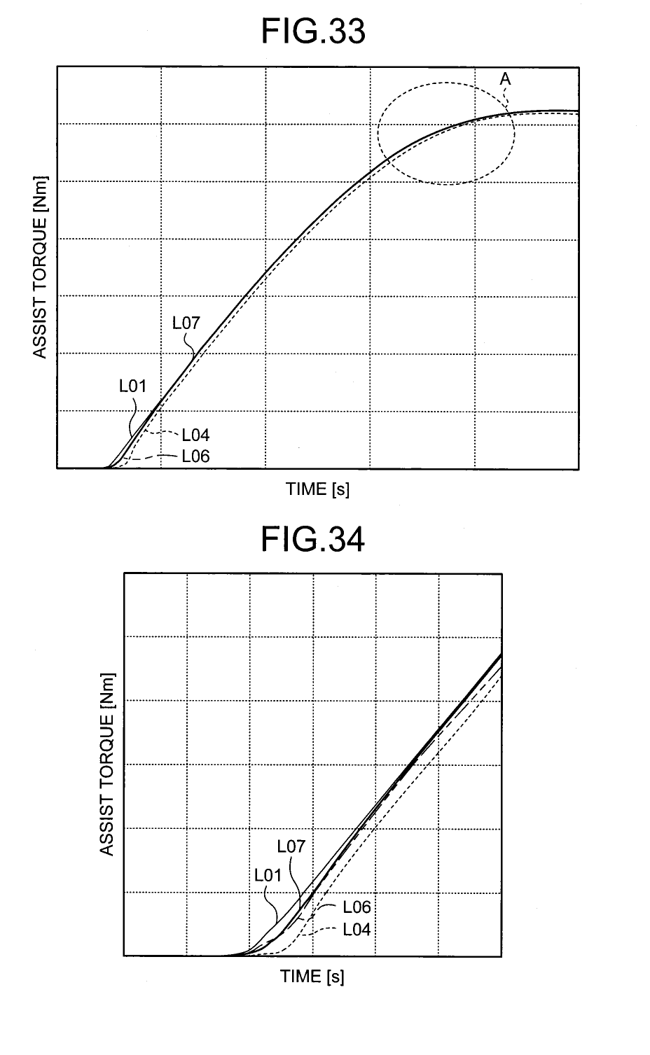

Next, a comparison with the known δ differentiation compensation will be explained referring to FIGS. 33, 34. FIG. 33 is a view exemplifying a time transition of the assist torque using the δ differentiation compensation as a comparative example, and FIG. 34 is an enlarged view illustrating an initial portion of the assist torque control in the time transition of the assist torque illustrated in FIG. 33.

In FIGS. 33, 34, graphs L06 illustrated by a single-dashed line illustrate a time transition of the assist torque TA output from the EPS actuator 300 when the δ differentiation compensation is applied to the assist torque control likewise FIGS. 26, 27. Note that graphs L01, L04, L07 are the same as those of FIGS. 29, 30.

As illustrated in the graph L06 of FIG. 34, when the δ differentiation compensation is applied to the assist torque control, although the responsiveness of the assist torque can be more improved than the case that only the basic assist torque TAbase is used as the assist torque target value TAtag (graph L04) as explained referring to FIGS. 26, 27, a response delay at the time of rising still remains and a deviation also remains.

In contrast, in the previously read curvature correction of the embodiment, as illustrated in the graphs L07 of FIGS. 33, 34, it becomes possible to cause the assist torque TA to more approach the target assist characteristics L01 from the beginning of steering in comparison with the δ differentiation compensation (graphs L06).

As described above, the previously read curvature correction of the embodiment (graphs L07) can cause the assist torque TA to preferably approach the target assist characteristics L01 from the beginning of steering in comparison with the conventional compensation methods such as the torque differentiation compensation (graphs L05) and the δ differentiation compensation (graphs L06). Accordingly, it is possible to execute the assist torque control in more conformity with the feeling of the driver.

### Sixth Embodiment

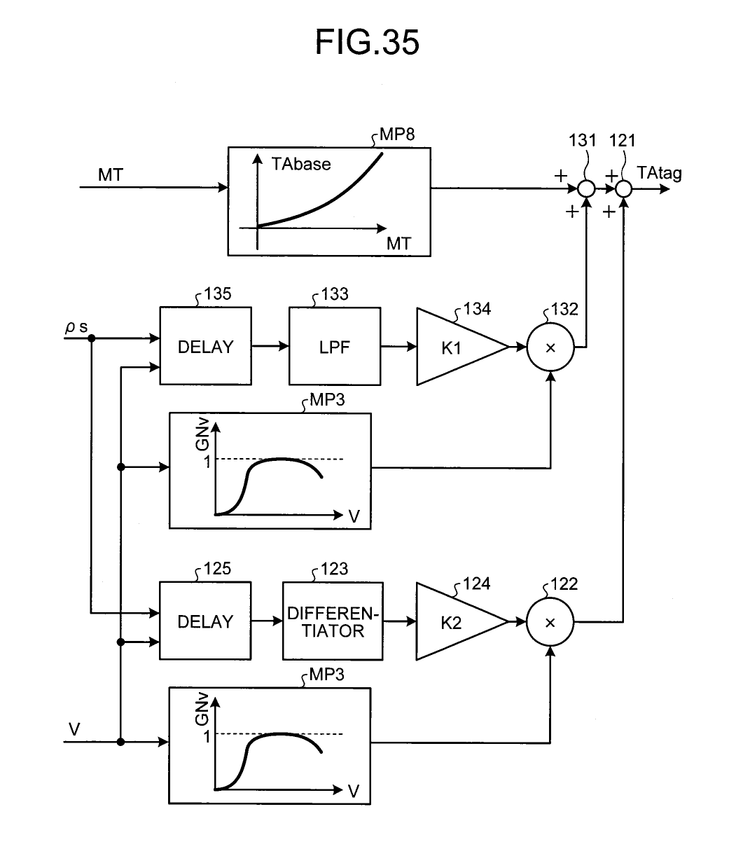

Next, a sixth embodiment of the present invention will be explained referring to FIG. 35 to FIG. 41.

The sixth embodiment combines the previously read curvature differentiation correction of the fourth embodiment with the previously read curvature correction of the fifth embodiment. That is, in the sixth embodiment, assist torque is controlled using a correction amount of assist torque control calculated based on a time change amount (differential value) of a previously read curvature ρ′(t) and a correction amount of assist torque control calculated based on the previously read curvature ρ′(t) together.

FIG. 35 is a control block diagram of the assist torque control in the embodiment. As illustrated in FIG. 35, a target value TAtag of the assist torque TA is shown as Expression (49) by operation of adders 121, 131.

TAtag=TAbase+dρV1+dρV2 (49)

In Expression (49), TAbase is basic assist torque for setting a reference to the assist torque and set by a control map MP8 likewise the fourth and fifth embodiments.

Further, Expression (49), dρV1 is a correction amount of the assist torque derived based on a previously read curvature ρs with symbol and calculated making use of a multiplier 132, a low-pass filter (LPF) 133, a gain multiplier 134, a delay (delay device) 135, and a control map MP3 likewise the fifth embodiment.

Further, dρV2 is a correction amount of the assist torque derived based on a differential value of the previously read curvature ρs with symbol and calculated making use of a multiplier 122, a differentiator 123, a gain multiplier 124, a delay (delay device) 125 and the control map MP3 likewise the fourth embodiment.

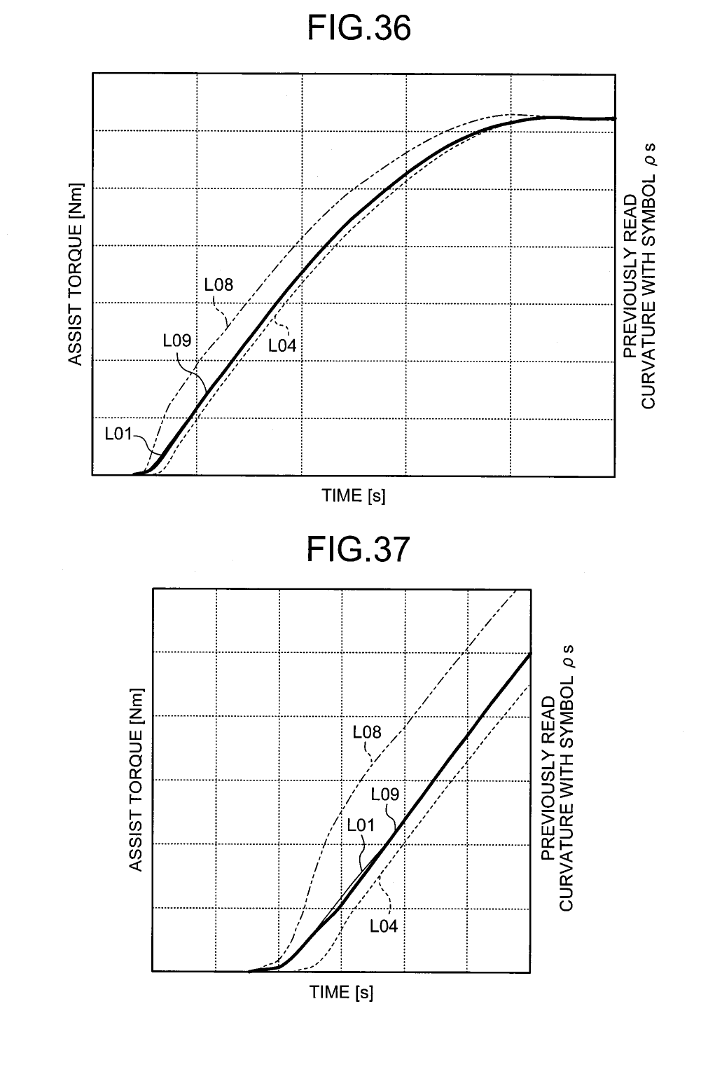

An effect of the assist torque control of the embodiment will be explained referring to FIG. 36, 37. FIG. 36 is a view exemplifying a time transition of the assist torque in an executing process of the assist torque control, and FIG. 37 is an enlarged view illustrating an initial portion of the assist torque control in the time transition of the assist torque illustrated in FIG. 36.

In FIGS. 36, 37, graphs L09 illustrated by a thick solid line illustrate a time transition of the assist torque TA output from an EPS actuator 300 when a previously read curvature correction for adding an assist torque correction amount dρV1 of the embodiment to an assist torque target value TAtag and a previously read curvature differentiation correction for adding an assist torque correction amount dρV2 to the assist torque target value TAtag are applied. Note that, likewise FIG. 29, a graph L01 illustrates target assist characteristics, a graph L04 illustrates a time transition of the assist torque TA output from the EPS actuator 300 when the previously read curvature correction and the previously read curvature differentiation correction of the embodiment are not executed (when only the basic assist torque TAbase is used as the assist torque target value TAtag) as an comparative example, and a graph L08 illustrates a time transition of a previously read curvature ρs with symbol in conformity with a scale of the assist torque.

As illustrated in the graphs L04 of FIGS. 36, 37, in a comparative example in which only the basic assist torque TAbase derived from the control map MP8 of FIG. 35 is used as the assist torque target value TAtag, the time transition of the assist torque TA output from the EPS actuator 300 has a large response delay with respect to the target assist characteristics L01 at the time of rising and although the time transition follows the target assist characteristics L01, a steady deviation remains. As described above, when only the basic assist torque TAbase is used as the assist torque target value TAtag, since a sufficient assist torque TA in response to a steering torque MT cannot be realized due to, in particular, the response delay of the assist torque TA at the beginning of steering, there may be a possibility that steering characteristics in conformity with an intention of the driver cannot be acquired.

In contrast, in the embodiment, to preferably supply the assist torque TA to assist the steering torque MT of the driver, the assist torque TA is controlled based on the previously read curvature ρ′ and its differential value. More specifically, as illustrated in the graphs L09 of FIGS. 36, 37, the embodiment is configured such that the assist torque correction amount dρV1 is calculated based on the previously read curvature ρ′ which makes a time transition similar to the target assist characteristics L01 as well as has a timing of the time transition faster than the target assist characteristics L01 and further calculates the assist torque correction amount dρV2 based on the differential value of the previously read curvature ρ′, and the assist torque correction amount dρV1 and the assist torque correction amount dρV2 are added to the assist torque target value TAtag.

With the configuration, in the embodiment, since it becomes possible to control the assist torque target value TAtag based on the previously read curvature ρ′ and its differential value in a feed forward fashion, it becomes possible to cause the assist torque TA to approach the target assist characteristics L01 from the beginning of steering in comparison with the comparative example (graphs L04) as illustrated in the graphs L09 of FIGS. 36, 37. Further, it becomes possible to cause the assist torque TA to approach the target assist characteristics L01 from the beginning of steering in comparison also with the case that the previously read curvature differentiation correction of the fourth embodiment (graphs L03 of FIGS. 22, 23) or the previously read curvature correction of the fifth embodiment (graphs L07 of FIGS. 29, 30) is individually applied. Accordingly, since the steering torque is not increased by the response delay of the assist torque at the beginning of steering, steering characteristics in conformity with the intention of the driver can be acquired, so that the assist torque control in conformity with the feeling of the driver can be executed.

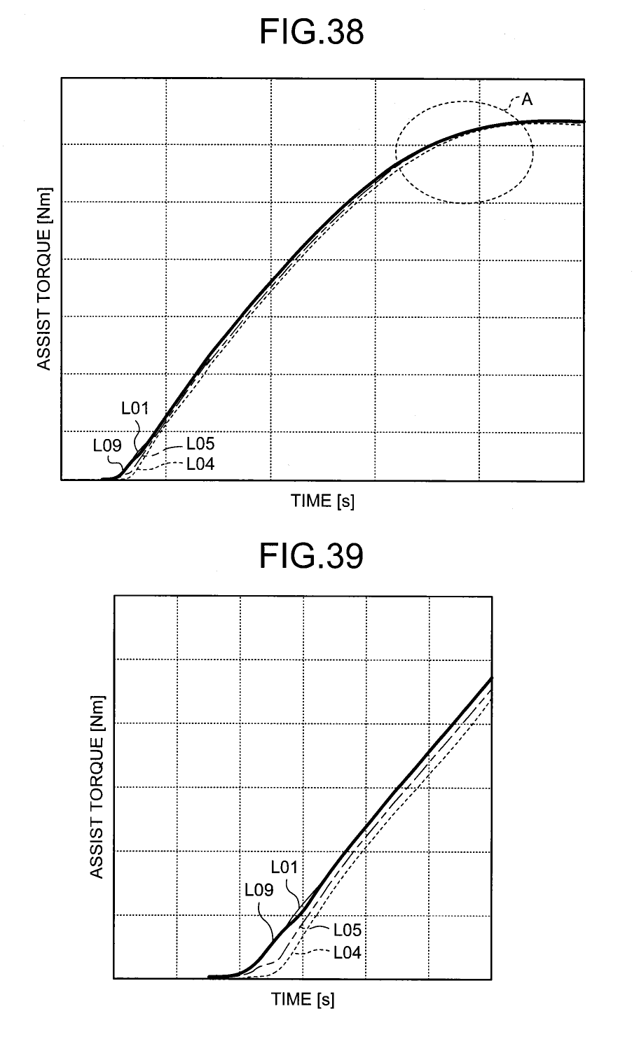

Next, the effect of the embodiment will be further explained by comparing the embodiment with the conventional compensation methods. First, a comparison with known torque differentiation compensation will be explained referring to FIGS. 38, 39. FIG. 38 is a view exemplifying a time transition of the assist torque using torque differentiation compensation as a comparative example, and FIG. 39 is an enlarged view illustrating an initial portion of the assist torque control in the time transition of the assist torque illustrated in FIG. 38.

In FIGS. 38, 39, graphs L05 illustrated by a single-dashed line illustrate a time transition of the assist torque TA output from the EPS actuator 300 when the torque differentiation compensation is applied to the assist torque control likewise FIGS. 24, 25. Note that the graphs L01, L04, L09 are the same as those of FIGS. 36, 37.

Accordingly, as illustrated in the graph L05 of FIG. 39, when the torque differentiation compensation is applied to the assist torque control, although responsiveness of the assist torque can be more improved than the case that only the basic assist torque TAbase is used as the assist torque target value TAtag (graph L04) as explained referring to FIGS. 24, 25, a response delay at the time of rising still remains and a deviation also remains.

In contrast, in the embodiment, as illustrated in graphs L09 illustrated in FIGS. 38, 39, it becomes possible to cause the assist torque TA to more approach the target assist characteristics L01 from the beginning of steering in comparison with the torque differentiation compensation (the graph L05).

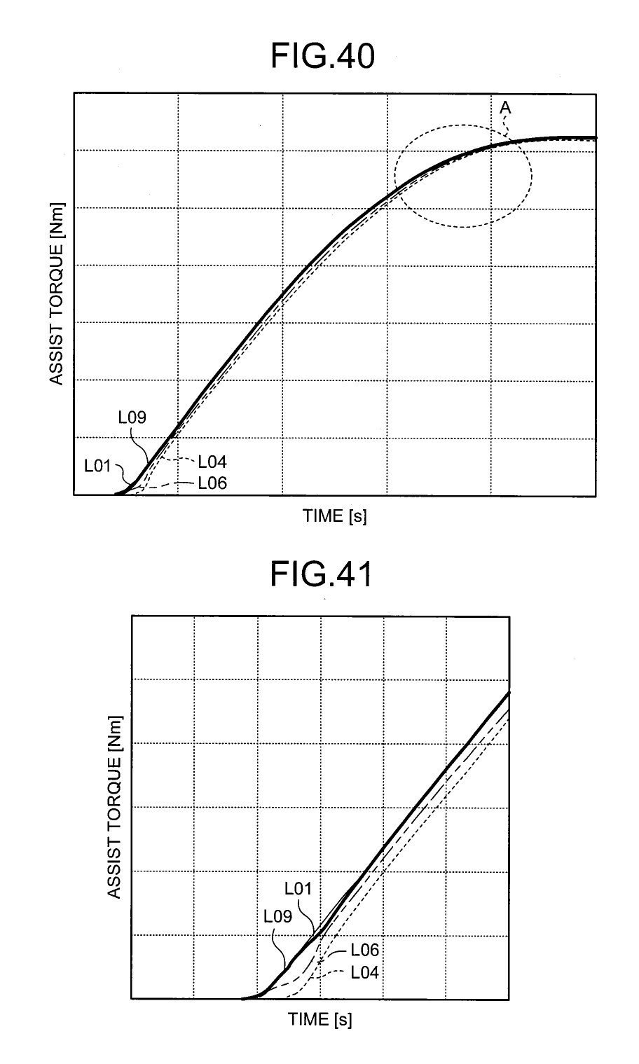

Next, a comparison with the known 8 differentiation compensation will be explained referring to FIGS. 40, 41. FIG. 40 is a view exemplifying a time transition of the assist torque using the 8 differentiation compensation as a comparative example, and FIG. 41 is an enlarged view illustrating an initial portion of the assist torque control in the time transition of the assist torque illustrated in FIG. 40.

In FIGS. 40, 41, graphs L06 illustrated by a single-dashed line illustrate a time transition of the assist torque TA output from the EPS actuator 300 when the δ differentiation compensation is applied to the assist torque control likewise FIGS. 26, 27. Note that graphs L01, L04, L09 are the same as those of FIGS. 36, 37.

As illustrated in the graph L06 of FIG. 41, when the δ differentiation compensation is applied to the assist torque control, although the responsiveness of the assist torque can be improved than the case that only the basic assist torque TAbase is used as the assist torque target value TAtag (graph L04) as explained referring to FIGS. 26, 27 a response delay at the time of rising still remains and a deviation also remains.

In contrast, in the previously read curvature correction and the previously read curvature differentiation correction of the embodiment, as illustrated in the graphs L09 of FIGS. 40, 41, it becomes possible to cause the assist torque TA to more approach the target assist characteristics L01 from the beginning of steering in comparison with the δ differentiation compensation (graph L06).

As described above, in the correction method (graph L09) in which the previously read curvature correction and the previously read curvature differentiation correction of the embodiment are combined, it becomes possible to cause the assist torque TA to preferably approach the target assist characteristics L01 from the beginning of steering in comparison with the conventional compensation methods such as the torque differentiation compensation (graph L05), the δ differentiation compensation (graph L06), and the like. Accordingly, assist torque control in more conformity with the feeling of the driver can be executed.

### Seventh Embodiment

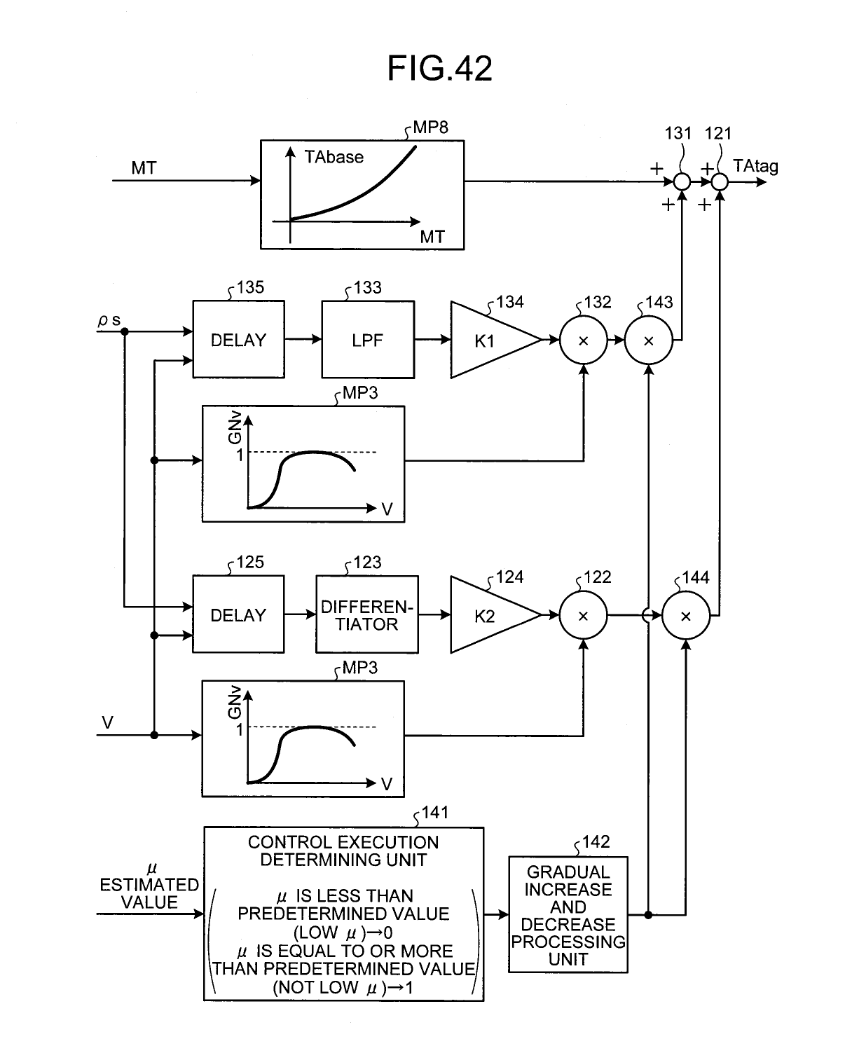

Next, a seventh embodiment of the present invention will be explained referring to FIG. 42. The embodiment adds a function for determining whether or not a previously read curvature differentiation correction (process for adding the assist torque correction amount dρV2 of the fourth and sixth embodiments to an assist torque target value TAtag) or a previously read curvature correction (process for adding the assist torque correction amount dρV1 of the fifth and sixth embodiments to the assist torque target value TAtag) is executed based on a road surface friction coefficient μ to the fourth to sixth embodiments.

FIG. 42 is a control block diagram of assist torque control in the embodiment. As illustrated in FIG. 42, the embodiment is configured to further including, as the function for determining whether or not an assist torque correction control is executed, a control execution determining unit 141 for determining whether or not the assist torque correction control is executed based on the road surface friction coefficient μ, a gradual increase and decrease processing unit 142 for subjecting an output value from the control execution determining unit 141 to a gradual increase or decrease process when the output value is switched, and multipliers 143, 144 for multiplying a gain value output from the gradual increase and decrease processing unit 142 to an assist torque correction amount dρV1 resulting from a previously read curvature correction output from the multiplier 132 and to an assist torque correction amount dρV2 resulting from a previously read curvature differentiation correction output from the multiplier 122.

The control execution determining unit 141 determines whether or not the assist torque correction control is executed based on an estimated value of the road surface friction coefficient μ (estimated μ value). More specifically, when the μ estimated value is equal to or more than a predetermined value, the control execution determining unit 141 determines to execute the assist torque correction control and outputs 1 as the output value. Further, when the μ estimated value is less than the predetermined value and the road surface friction coefficient μ is small (low μ state), the control execution determining unit 141 determines not to execute the assist torque correction control to prevent an excessive assist and outputs 0 as the output value. That is, when the μ estimated value changes from less than the predetermined value to equal to or more than the predetermined value, the control execution determining unit 141 switches the output value from 0 to 1, and further when the μ estimated value changes from equal to or more than the predetermined value to less than the predetermined value, the control execution determining unit 141 switches the output value from 1 to 0.

Note that the estimated value (μ estimated value) of the road surface friction coefficient μ that is input information of the control execution determining unit 141 can be calculated using a known estimation method based on the information of various sensors of a vehicle 1. Included as the sensor information used to calculate the μ estimated value is the information from, for example, the steering angle sensor 17, the vehicle speed sensor 19, the yaw rate sensor 20, and the lateral acceleration sensor 21 which are described above and further the information from a vehicle wheel speed sensor for detecting wheel speeds of respective wheels FL, FR, a front-back acceleration sensor for detecting front-back acceleration of the vehicle 1, an upper-lower acceleration sensor for detecting upper-lower acceleration (acceleration in a vertical direction) of the vehicle 1, a master pressure sensor for detecting a pressure of a master cylinder, and the like.

The gradual increase and decrease processing unit 142 outputs the gain value to be multiplied to the assist torque correction amounts dρV1, dρV2 based on the output value of the control execution determining unit 141. Specifically, when the output value of the control execution determining unit 141 is 0 or 1 and constant, the gradual increase and decrease processing unit 142 outputs the output value as it is as the gain value, and, in particular, when the output value from the control execution determining unit 141 changes from 0 to 1 or from 1 to 0, the gradual increase and decrease processing unit 142 executes a gradually increasing or decreasing process to gradually change the output value in a predetermined time to prevent the gain value from being abruptly switched. When, for example, the control execution determining unit 141 switches the determination from that the control can be executed to that the control cannot be executed, although the output value is switched from 1 to 0, the output value is not instantly switched but switched from 1 to 0 stepwise, so that an abrupt variation of the assist torque can be prevented. Note that in the control execution determining unit 141, when the determination that the control cannot be executed (output value: 0) is switched to the determination that the control can be executed (output value: 1), the output value is changed stepwise likewise.

An effect of the embodiment will be explained. In general, when the road surface friction coefficient μ is low (at the time of low μ) since self-aligning torque becomes small as compared with a case that the self-aligning torque is high, a necessary assist force may be small. In contrast, since the assist torque correction amounts dρV1, dρV2 derived from the previously read curvature correction and the previously read curvature differentiation correction have gains K1, K2 that are constant, an excessive assist may be executed at the time of low μ. To cope with the problem, in the embodiment, a permission condition as to the road surface friction coefficient μ is provided in the assist torque control to execute the assist torque control only in a status in which the assist can be executed appropriately, with a result that control in more conformity with a feeling of a driver can be executed.

Note that although FIG. 42 exemplifies the configuration of the sixth embodiment including both the previously read curvature differentiation correction and the previously read curvature correction, the seventh embodiment can be also applied to the configuration of the fourth embodiment including only the previously read curvature differentiation correction illustrated in FIG. 21 and to the configuration of the fifth embodiment including only the previously read curvature correction illustrated in FIG. 28.

### Eighth Embodiment

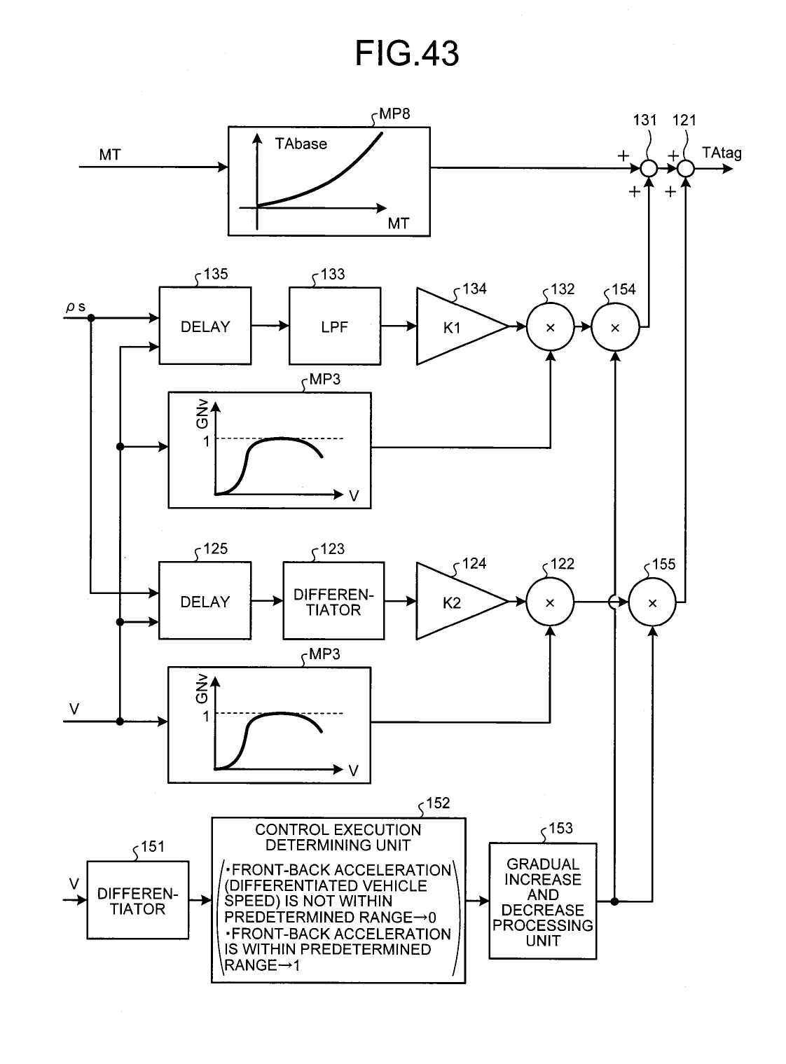

Next, an eighth embodiment of the present invention will be explained referring to FIG. 43. The embodiment adds a function for determining whether or not a previously read curvature differentiation correction (process for adding the assist torque correction amount dρV2 of the fourth and sixth embodiments to an assist torque target value TAtag) or a previously read curvature correction (process for adding the assist torque correction amount dρV1 of the fifth and sixth embodiments to the assist torque target value TAtag) is executed based on acceleration of a vehicle 1 to the fourth to sixth embodiments.

FIG. 43 is a control block diagram of assist torque control in the embodiment. As illustrated in FIG. 43, the embodiment is configured to further include a differentiator 151 for differentiating a vehicle speed V, a control execution determining unit 152 for determining whether or not assist torque correction control is executed based on the acceleration of the vehicle 1 calculated by the differentiator 151, a gradual increase and decrease processing unit 153, and multipliers 154, 155. Note that the gradual increase and decrease processing unit 153 and the multipliers 154, 155 have the same functions as those of the gradual increase and decrease processing unit 142 and the multipliers 143, 144 of the seventh embodiment.

The differentiator 151 calculates acceleration by differentiating the speed V of the vehicle 1 input thereto.

The control execution determining unit 152 determines whether or not the assist torque correction control is executed based on a value of the acceleration of the vehicle 1 calculated by the differentiator 151. More specifically, when front-back acceleration (differentiated vehicle speed) of the vehicle 1 is within a predetermined range, the control execution determining unit 152 determines to execute the assist torque correction control and outputs 1 as an output value. Further, when the acceleration of the vehicle 1 is outside of the predetermined range, the control execution determining unit 152 determines not to execute the assist torque correction control to prevent an excessive assist and outputs 0 as the output value.

An effect of the embodiment will be explained. In general, at the time of acceleration or deceleration of the vehicle 1, self-aligning torque may become smaller as compared with the time of constant speed travel and, in the case, a necessary assist force may be small. In contrast, since assist torque correction amounts dρV1, dρV2 derived by a previously read curvature correction and a previously read curvature differentiation correction have constant gains K1, K2, the excessive assist may be executed at the time of acceleration and deceleration. To cope with the problem, in the embodiment, the assist torque control can be executed only in a status in which an assist can be appropriately executed by providing the permission condition as to acceleration and deceleration, with a result that a control in more conformity with the feeling of the driver can be executed.

Note that although FIG. 43 exemplifies the configuration of the sixth embodiment including both the previously read curvature differentiation correction and the previously read curvature correction, the embodiment can be also applied to the configuration of the fourth embodiment including only the previously read curvature differentiation correction illustrated in FIG. 21 and to the configuration of the fifth embodiment including only the previously read curvature correction illustrated in FIG. 28.

### Ninth Embodiment

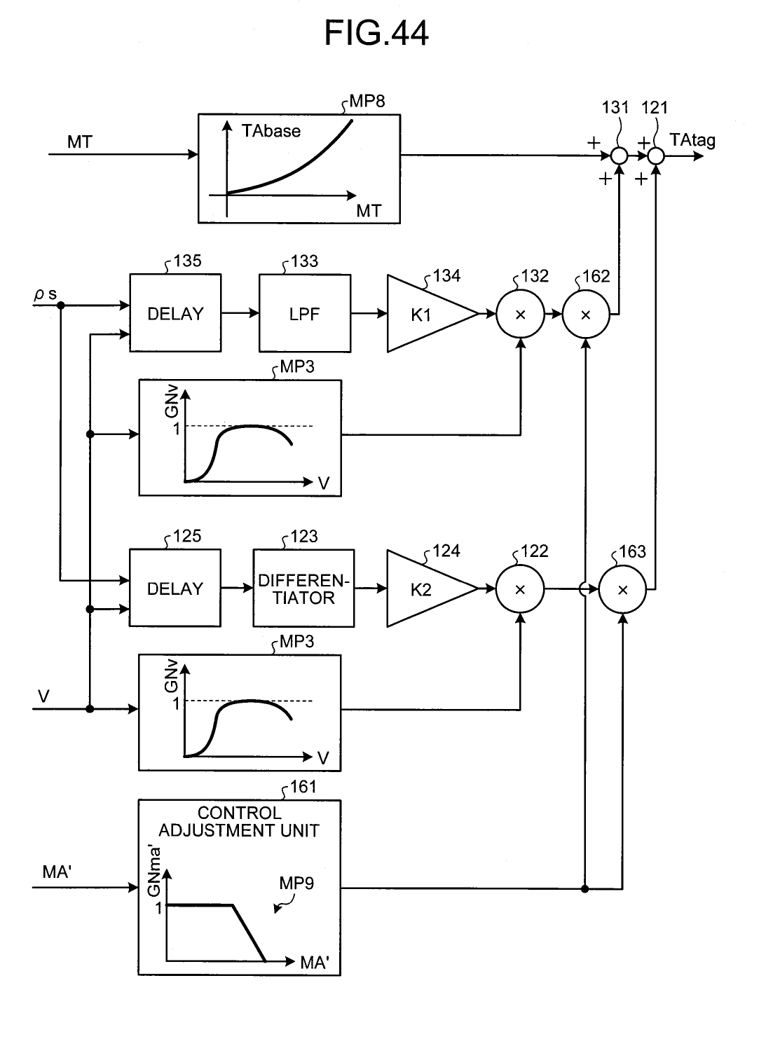

Next, a ninth embodiment of the present invention will be explained referring to FIG. 44. The embodiment adds a function for adjusting an addition ratio of a previously read curvature differentiation correction (process for adding the assist torque correction amount dρV2 of the fourth and sixth embodiments to an assist torque target value TAtag) or a previously read curvature correction (process for adding the assist torque correction amount dρV1 of the fifth and sixth embodiments to the assist torque target value TAtag) based on a steering angular speed MA′ to the fourth to sixth embodiments.

FIG. 44 is a control block diagram of the assist torque control in the embodiment. As illustrated in FIG. 44, the embodiment is configured to further include a control adjustment unit 161 for adjusting the addition ratio of the assist torque correction control based on the steering angular speed MA′ and multipliers 162, 163 for multiplying a gain value output from the control adjustment unit 161 by the assist torque correction amount dρV1 resulting from the previously read curvature correction output from the multiplier 132 and by the assist torque correction amount dρV2 resulting from the previously read curvature differentiation correction output from the multiplier 122.

As illustrated in FIG. 44, the control adjustment unit 161 includes a control map MP9 for causing the steering angular speed MA′ to correspond to an assist gain GNma′. The control adjustment unit 161 selects the assist gain GNma′ corresponding to the steering angular speed MA′ based on the steering angular speed MA′ input thereto using the control map MP9 and outputs the assist gain GNma′. As apparent from the control map MP9 exemplified in FIG. 44, the assist gain GNma′ is set to 1 in a region in which the steering angular speed MA′ is low and set so as to be reduced up to 0 in response to an increase of speed when a predetermined steering angular speed MA′ is exceeded. That is, in a region in which the steering angular speed MA′ is large (for example, in a state in which an operator swerves sharply for emergency avoidance, and the like) so that it is unlikely that the assist torque correction amount is added. In contrast, since a smaller steering angular speed MA′ more increases the assist gain GNma′, the addition ratio of the assist torque correction amount increases so that the assist torque can be increased.

An effect of the embodiment will be explained. In general, it is considered that when the steering angular speed MA′ is high, since information of the previously read curvature ρ′ has low accuracy, it is difficult to extract an intention of a driver. In the embodiment, in the region in which the steering angular speed MA′ is high, the assist control can be appropriately executed only in a status in which the steering angular speed MA′ is low and the intention of the driver can be extracted by reducing the assist gain GNma′ to reduce the assist torque correction amount.

The present invention is not limited to the embodiments described above and can be appropriately modified within a scope that does not depart from a gist or a technical idea which can be read from claims and description in its entirety, and a vehicle information processing device modified as described above is also included in a technical scope of the present invention.

For example, in the embodiments, although the assist torque TA is created by controlling the EPS actuator 300 (assist torque supplying means) based on the previously read curvature (estimated turning curvature) ρ′ or the differential value (time change amount) dρ2 of the previously read curvature ρ′ (previously read curvature ρs with symbol), an configuration for changing a relation (steering transmission ratio) between the steering angle MA (steering input) and a steering angle of the front wheel as the steering wheel by controlling the VGRS actuator 200 (steering angle variable means) may be employed in place of the configuration described above.

### REFERENCE SIGNS LIST

1 vehicle
11 steering wheel
12 upper steering shaft
100 ECU
200 VGRS actuator
300 EPS actuator

1-15. (canceled)

16. A vehicle information processing device mounted on a vehicle including at least one of a steering angle variable unit capable of changing a relation between a steering input and a steering angle of a steering wheel and an assist torque supplying unit capable of supplying assist torque for assisting steering torque of a driver, the vehicle information processing device comprising:
a future position calculating unit configured to calculate a future position of the vehicle based on steering input information corresponding to a steering input, a vehicle state amount that prescribes a turning state, and a vehicle speed;
an estimating unit configured to estimate a turning curvature of the vehicle at a provisional travel position ahead of a present position based on at least three vehicle positions according to the vehicle including at least the one calculated future position as well as including a vehicle position corresponding to the present position of the vehicle; and
a controller configured to control at least one of the steering angle variable unit and the assist torque supplying unit based on the estimated turning curvature, wherein
when the estimated turning curvature of the provisional travel position is larger at the time of cut operation executed by the driver, the controller more increases a dumping control term or a friction torque control term of the assist torque.

17. The vehicle information processing device according to claim 16, wherein
the future position calculating unit obtains a present position and a past position of the vehicle as well as calculates the future position based on the acquired present position and past position, steering input information corresponding to the steering input, a vehicle state amount that prescribes a turning state, and a vehicle speed.

18. The vehicle information processing device according to claim 16, wherein
the future position is a relative position prescribed by a relative position change amount with respect to a reference position.

19. The vehicle information processing device according to claim 16, further comprising:
a detecting unit configured to detect the vehicle state amount, wherein
the future position calculating unit makes use of the detected vehicle state amount to calculate the future position.

20. The vehicle information processing device according to claim 16, wherein
the steering input information is a steering angle, and the vehicle state amount is a yaw rate, lateral acceleration, and a vehicle body slip angle.

21. The vehicle information processing device according to claim 16, wherein
the at least three vehicle positions include three vehicle positions whose calculated times are adjacent to each other on a time series.

22. The vehicle information processing device according to claim 16, further comprising:
an acquiring unit configured to acquire a present position and a plurality of past positions of the vehicle, wherein
the estimating unit estimates the turning curvature of the vehicle at the present position based on the acquired present position and the plurality of past positions, and
the controller controls the assist torque based on the estimated turning curvature of the provisional travel position and a turning curvature of the estimated present position at the time of cut back of the steering input unit executed by the driver.

23. The vehicle information processing device according to claim 22, wherein
when a difference between a last time value of the estimated turning curvature of the provisional travel position and a present value of a turning curvature of the estimated present position is larger, the controller more increases the assist torque.

24. The vehicle information processing device according to claim 16, further comprising:
an acquiring unit configured to acquire a present position and a plurality of past positions of the vehicle, wherein
the estimating unit estimates a turning curvature of the vehicle at the present position based on the acquired present position and the plurality of past positions, and
when a deviation between the estimated turning curvature of the provisional travel position and a turning curvature of the estimated present position is larger at the time of cut operation executed by the driver, the controller more increases a dumping control term or a friction torque control term of the assist torque.

25. The vehicle information processing device according to claim 16, wherein
the controller controls at least one of the steering angle variable unit and the assist torque supplying unit based on a time change amount of the estimated turning curvature.

26. The vehicle information processing device according to claim 16, wherein
when a road surface friction coefficient is equal to or more than a predetermined value, the controller controls the assist torque.

27. The vehicle information processing device according to claim 16, wherein
when acceleration of the vehicle is within a predetermined range, the controller controls the assist torque.

28. The vehicle information processing device according to claim 16, wherein
as a steering angular speed is smaller, the controller more increases the assist torque.

29. The vehicle information processing device according to claim 17, wherein
the future position is a relative position prescribed by a relative position change amount with respect to a reference position.

30. The vehicle information processing device according to claim 17, further comprising:
a detecting unit configured to detect the vehicle state amount, wherein
the future position calculating unit makes use of the detected vehicle state amount to calculate the future position.

31. The vehicle information processing device according to claim 18, further comprising:
a detecting unit configured to detect the vehicle state amount, wherein
the future position calculating unit makes use of the detected vehicle state amount to calculate the future position.

32. The vehicle information processing device according to claim 17, wherein
the steering input information is a steering angle, and the vehicle state amount is a yaw rate, lateral acceleration, and a vehicle body slip angle.

33. The vehicle information processing device according to claim 18, wherein
the steering input information is a steering angle, and the vehicle state amount is a yaw rate, lateral acceleration, and a vehicle body slip angle.

34. The vehicle information processing device according to claim 19, wherein
the steering input information is a steering angle, and the vehicle state amount is a yaw rate, lateral acceleration, and a vehicle body slip angle.

35. The vehicle information processing device according to claim 17, wherein
the at least three vehicle positions include three vehicle positions whose calculated times are adjacent to each other on a time series.
